(19) United States
(12) Patent Application Publication
(10) Pub. No.: US 2025/0044563 A1
(43) Pub. Date: Feb. 6, 2025

(54) OPTICAL SYSTEM, IMAGE PROJECTION DEVICE AND IMAGING DEVICE

(71) Applicant: Panasonic Intellectual Porperty Management Co., Ltd., Osaka (JP)

(72) Inventor: Shunichiro Yoshinaga, Osaka (JP)

(21) Appl. No.: 18/655,686

(22) Filed: May 6, 2024

(30) Foreign Application Priority Data
Jul. 31, 2023 (JP) 2023-124566

(51) Int. Cl. G02B 15/22; G02B 13/00; G02B 13/16

(52) U.S. Cl. CPC G02B 15/22; G02B 13/0015; G02B 13/0095; G02B 13/16

(57) ABSTRACT

An optical system including an intermediate image forming position, the intermediate image forming position being conjugate with each of an enlargement conjugate point on an enlargement side and a reduction conjugate point on a reduction side, the optical system comprising: an enlargement optical system; and a relay optical system located closer to the reduction side than the intermediate image forming position, the relay optical system including: a positive lens element disposed on a most reduction side; and a focusing lens group on a most enlargement side that moves in an optical axis direction during focusing, the focusing lens group including two negative lens elements having negative power, and satisfying Expression (1) described below.

$$0.65 < \vert dn / fFg 1 \vert < 2.29 \qquad ( 1 )$$

Here, dn is a maximum value of a distance on the optical axis between the two negative lens elements, and fFg1 is a focal distance of the focusing lens group.

### BACKGROUND

### 1. Technical Field

The present disclosure relates to an optical system that forms an intermediate image. The present disclosure also relates to an image projection device and an imaging device using an optical system as described above.

### 2. Description of the Related Art

Market requires a projection optical system that can cope with a wide projection size range under a wide variety of projection conditions. However, expanding the projection size range typically requires coping with a wide projection distance range, and thus increasing the amount of movement of a focus group. To maintain good optical performance even when the amount of movement of the focus group increases, good intra-group aberration correction of the focus group is ideally only required to be performed to prevent image plane curvature from varying. However, forming such a focus group requires a large number of lenses, so that introduction of an aspherical lens may be required, and thus leading to an increase in cost and size of an optical system. Additionally, an actuator and a mechanical component for driving the focus group are also increased in size at the same time, so that adverse effects on cost and size are also considered.

To avoid such side effects, focusing without aberration variation can be performed by relaxing the intra-group aberration correction of the focus group to some extent, allowing aberration variation that occurs with movement of the focus group, separately providing an image plane curvature adjustment group having a function of canceling the aberration variation, and independently moving the focus group and the image plane curvature adjustment group in an optical axis direction.

However, when the intra-group aberration correction of the focus group becomes equal to or lower than a certain level even in this case, the aberration variation along with movement of the focus group, particularly image plane curvature variation, becomes remarkable. Thus, a load of an image plane curvature adjustment unit serving to cancel the aberration variation increases, thereby causing difficulty in simultaneously and favorably correcting the image plane curvature, distortion, chromatic aberration, and the like.

WO 2022-239274 A discloses an optical system that facilitates focus adjustment and achieves reduction in size and weight of a focus mechanism. However, intra-group aberration correction of a focus group is insufficient. Thus, even when aberration correction is performed by an image plane curvature adjustment group, a projectable distance range is narrow, and thus the optical system cannot cope with a wide projection size range.

JP 2021-76771 A discloses an image forming optical system that is capable of downsizing a lens diameter while having a wide angle and that has good optical performance in a wide projection distance range. However, the focus group includes one lens, so that intra-group aberration correction of the focus group has not been achieved. Thus, even when various aberrations are corrected by an image plane curvature adjustment group, it is difficult to sufficiently correct image plane curvature, distortion, chromatic aberration, and the like at the same time.

### SUMMARY

The present disclosure provides an optical system that can maintain good optical performance over a wide projection size range and can achieve small size and light weight. The present disclosure also provides an image projection device and an imaging device using an optical system as described above.

An aspect of the present disclosure is an optical system including an intermediate image forming position inside the optical system, the intermediate image forming position being conjugate with each of an enlargement conjugate point on an enlargement side and a reduction conjugate point on a reduction side, the optical system comprising: an enlargement optical system located closer to the enlargement side than the intermediate image forming position; and a relay optical system located closer to the reduction side than the intermediate image forming position, the relay optical system including: a positive lens element disposed on a most reduction side; and a focusing lens group on a most enlargement side that moves in an optical axis direction during focusing, the focusing lens group including two negative lens elements having negative power, and satisfying Expression (1) described below.

$$0.65 < \vert dn / fFg 1 \vert < 2.29 \qquad ( 1 )$$

Here, dn is a maximum value of a distance on the optical axis between the two negative lens elements, and fFg1 is a focal distance of the focusing lens group.

An image projection device according to the present disclosure comprises the optical system described above and an image forming element that generates an image to be projected onto a screen through the optical system.

An imaging device according to the present disclosure comprises the optical system described above and an imaging element that receives an optical image formed by the optical system to convert the optical image into an electrical image signal.

The optical system of the present disclosure enables maintaining good optical performance over a wide projection distance range, and achieving an optical system that is small in size and light in weight.

### BRIEF DESCRIPTION OF THE DRAWINGS

FIG. 1 is an arrangement diagram illustrating an optical path at a wide angle end of a zoom lens of Example 1 at an object distance of 979.4417 mm;

FIG. 2 is an arrangement diagram of the wide angle end of the zoom lens of Example 1 at the object distance of 979.4417 mm;

FIG. 3 is a longitudinal aberration diagram of the zoom lens of Example 1 and includes part (a) at the wide angle end at the object distance of 979.4417 mm, part (b) at an intermediate position at an object distance of 1014.6519 mm, and part (c) at a telephoto end at an object distance of 1048.7004 mm;

FIG. 4 is a longitudinal aberration diagram of the zoom lens of Example 1 and includes part (a) at a wide angle end at an object distance of 640.2217 mm, part (b) at an intermediate position at an object distance of 662.9035 mm, and part (c) at a telephoto end at an object distance of 686.3889 mm;

FIG. 5 is a longitudinal aberration diagram of the zoom lens of Example 1 and includes part (a) at a wide angle end at an object distance of 6746.9034 mm, part (b) an intermediate position at an object distance of 6974.4484 mm, and part (c) at a telephoto end at an object distance of 7209.6675 mm;

FIG. 6 is an arrangement diagram illustrating an optical path at a wide angle end of a zoom lens of Example 2 at an object distance of 982.2430 mm;

FIG. 7 is an arrangement diagram of the wide angle end of the zoom lens of Example 2 at the object distance of 982.2430 mm;

FIG. 8 is a longitudinal aberration diagram of the zoom lens of Example 2 and includes part (a) at the wide angle end at the object distance of 982.2430 mm, part (b) at an intermediate position at an object distance of 1016.5500 mm, and part (c) at a telephoto end at an object distance of 1051.6500 mm;

FIG. 9 is a longitudinal aberration diagram of the zoom lens of Example 2 and includes part (a) at a wide angle end at an object distance of 648.9340 mm, part (b) at an intermediate position at an object distance of 668.3514 mm, and part (c) at a telephoto end at an object distance of 688.3500 mm;

FIG. 10 is a longitudinal aberration diagram of the zoom lens of Example 2 and includes part (a) at a wide angle end at an object distance of 6838.0200 mm, part (b) at an intermediate position at an object distance of 7032.3438 mm, and part (c) at a telephoto end at an object distance of 7232.1900 mm;

FIG. 11 is an arrangement diagram illustrating an optical path at a wide angle end of a zoom lens of Example 3 at an object distance of 982.2430 mm;

FIG. 12 is an arrangement diagram of the wide angle end of the zoom lens of Example 3 at the object distance of 982.2430 mm;

FIG. 13 is a longitudinal aberration diagram of the zoom lens of Example 3 and includes part (a) at the wide angle end at the object distance of 982.2430 mm, part (b) at an intermediate position at an object distance of 1016.5500 mm, and part (c) at a telephoto end at an object distance of 1051.6500 mm;

FIG. 14 is a longitudinal aberration diagram of the zoom lens of Example 3 and includes part (a) at a wide angle end at an object distance of 648.9340 mm, part (b) at an intermediate position at an object distance of 668.3514 mm, and part (c) at a telephoto end at an object distance of 688.3500 mm;

FIG. 15 is a longitudinal aberration diagram of the zoom lens of Example 3 and includes part (a) at a wide angle end at an object distance of 6838.0200 mm, part (b) at an intermediate position at an object distance of 7032.3438 mm, and part (c) at a telephoto end at an object distance of 7232.1900 mm;

FIG. 16 is an arrangement diagram illustrating an optical path at a wide angle end of a zoom lens of Example 4 at an object distance of 1780.3701 mm;

FIG. 17 is an arrangement diagram of the wide angle end of the zoom lens of Example 4 at the object distance of 1780.3701 mm;

FIG. 18 is a longitudinal aberration diagram of the zoom lens of Example 4 and includes part (a) at the wide angle end at the object distance of 1780.3701 mm, part (b) at an intermediate position at an object distance of 2027.5398 mm, and part (c) at a telephoto end at an object distance of 2204.3709 mm;

FIG. 19 is a longitudinal aberration diagram of the zoom lens of Example 4 and includes part (a) at a wide angle end at an object distance of 1177.3665 mm, part (b) at an intermediate position at an object distance of 1342.3017 mm, and part (c) a telephoto end at an object distance of 1460.3135 mm;

FIG. 20 is a longitudinal aberration diagram of the zoom lens of Example 4 and includes part (a) at a wide angle end at an object distance of 12031.557 mm, part (b) at an intermediate position at an object distance of 13676.725 mm, and part (c) at a telephoto end at an object distance of 14853.495 mm;

FIG. 21 is a block diagram illustrating an example of an image projection device according to the present disclosure; and

FIG. 22 is a block diagram illustrating an example of an imaging device according to the present disclosure.

### DETAILED DESCRIPTION

Hereinafter, exemplary embodiments will be described in detail with reference to the drawings as appropriate. However, detailed description more than necessary may not be described. For example, detailed descriptions of a well-known matter or duplicated descriptions of substantially the same configurations may not be described. This is to prevent the description below from being unnecessarily redundant and to facilitate understanding of a person skilled in the art. The applicant provides the accompanying drawings and the following description to allow a person skilled in the art to fully understand the present disclosure, and does not intend to limit the subject matter as described in the scope of claims.

Each example of an optical system according to the present disclosure will be described below. Each example will be described in which the optical system is used for a projector (an example of an image projection device) that projects image light of original image S onto a screen, the image light being obtained by spatially modulating incident light using an image forming element such as a liquid crystal or a digital micromirror device (DMD) based on an image signal. That is, the optical system according to the present disclosure is available to project original image S, which is on an image forming element disposed on a reduction side, onto a screen (not illustrated) in an enlarged manner by disposing the screen on an extension line on an enlargement side. The optical system according to the present disclosure is also available to collect light emitted from an object located on the extension line on the enlargement side to form an optical image of the object on an imaging surface of an imaging element disposed on the reduction side.

### Exemplary Embodiments

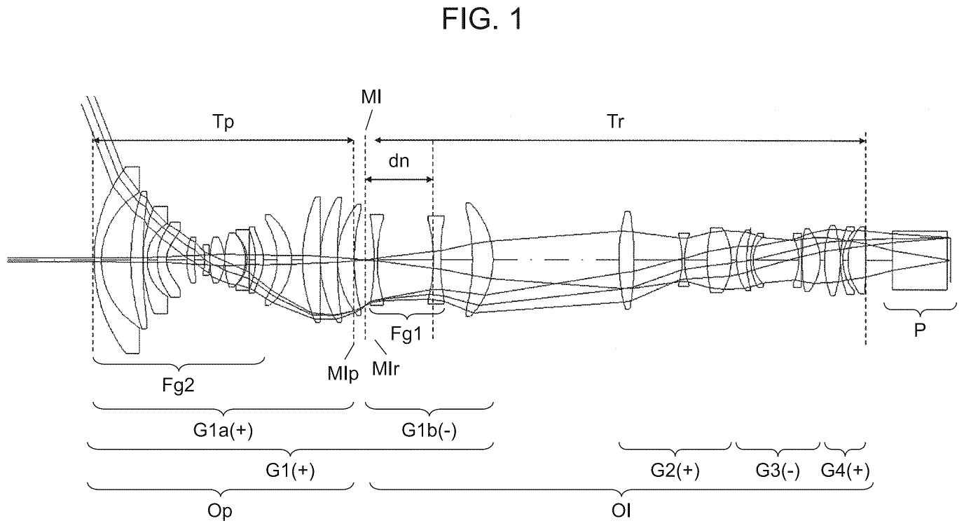

Hereinafter, a first exemplary embodiment of the present disclosure will be described with reference to FIGS. 1 to 20. Here, a zoom lens system will be described as an example of the optical system.

FIG. 1 illustrates an optical path at a wide angle end of a zoom lens system of Example 1 at an object distance of 979.4417 mm.

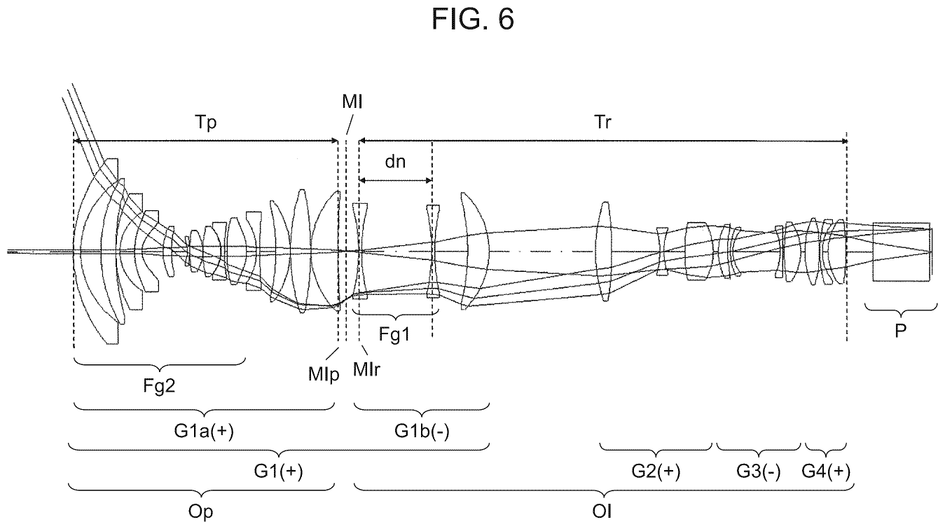

FIG. 6 illustrates an optical path at a wide angle end of a zoom lens system of Example 2 at an object distance of 982.2430 mm.

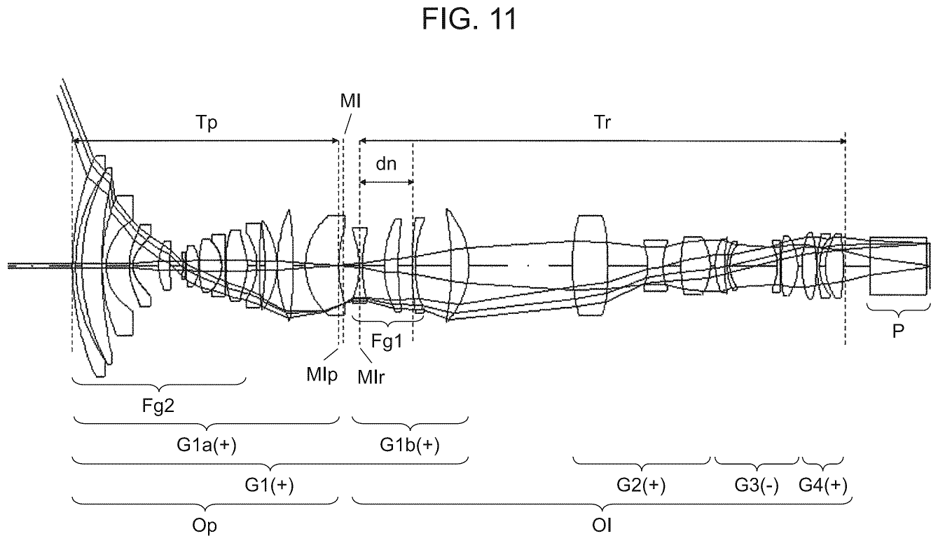

FIG. 11 illustrates an optical path at a wide angle end of a zoom lens system of Example 3 at an object distance of 982.2430 mm.

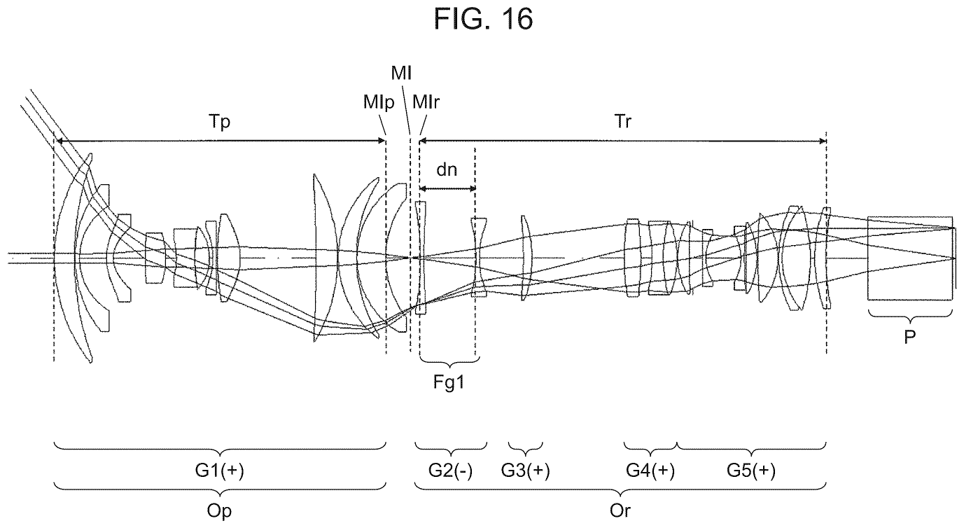

FIG. 16 illustrates an optical path at a wide angle end of a zoom lens system of Example 4 at an object distance of 1780.3701 mm.

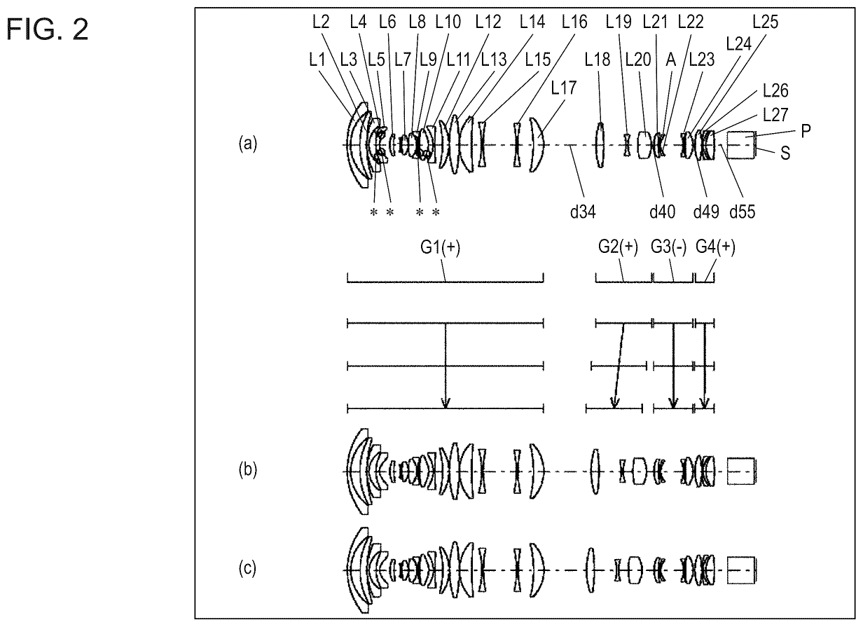

FIG. 2 illustrates an arrangement diagram of the wide angle end of the zoom lens system of Example 1 at the object distance of 979.4417 mm.

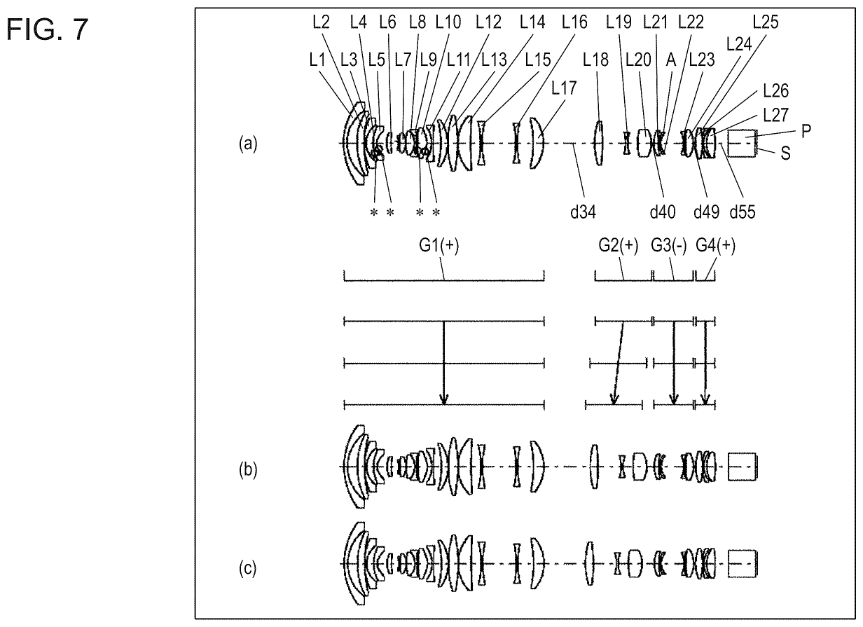

FIG. 7 illustrates an arrangement diagram of the wide angle end of the zoom lens system of Example 2 at the object distance of 982.2430 mm.

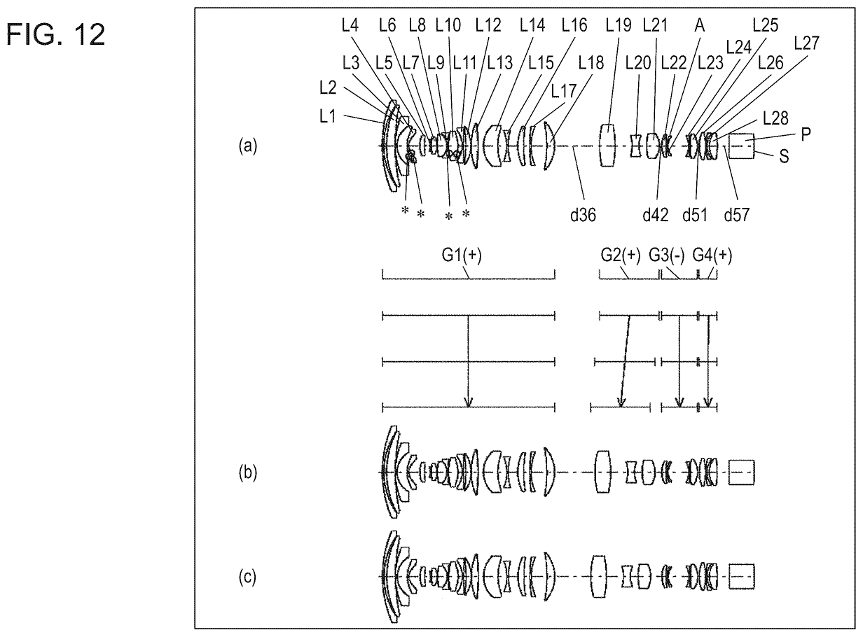

FIG. 12 illustrates an arrangement diagram of the wide angle end of the zoom lens system of Example 3 at the object distance of 982.2430 mm.

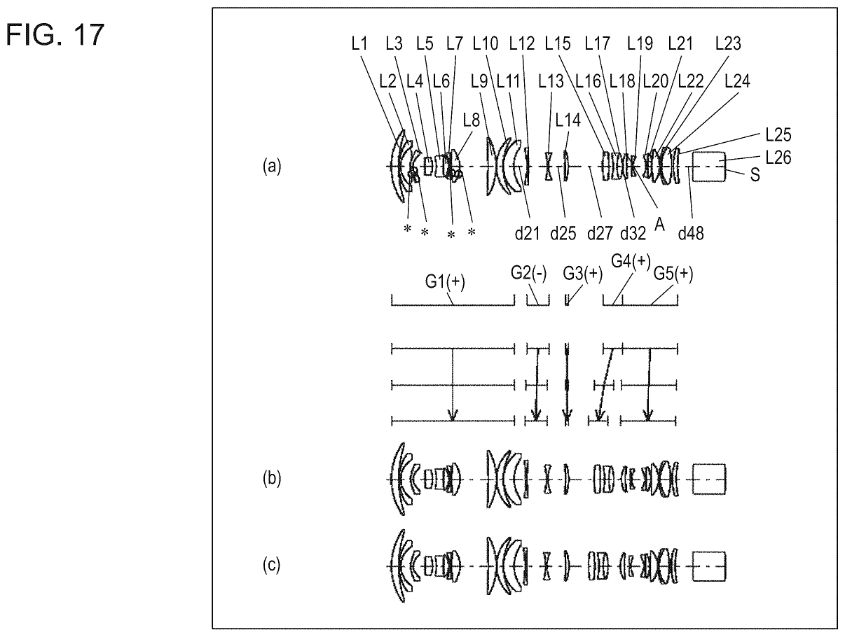

FIG. 17 illustrates an arrangement diagram of the wide angle end of the zoom lens system of Example 4 at an object distance of 1780.3701 mm.

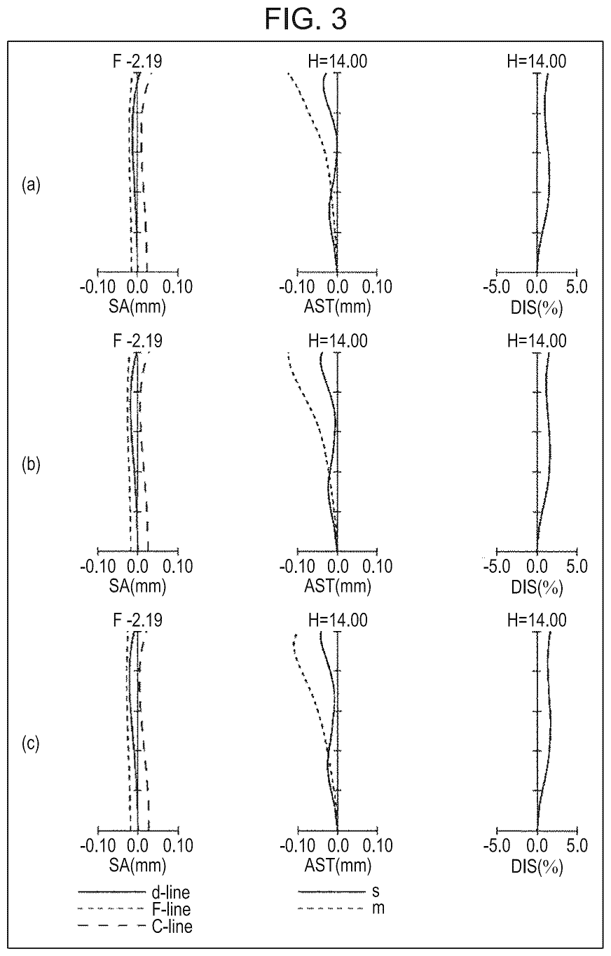

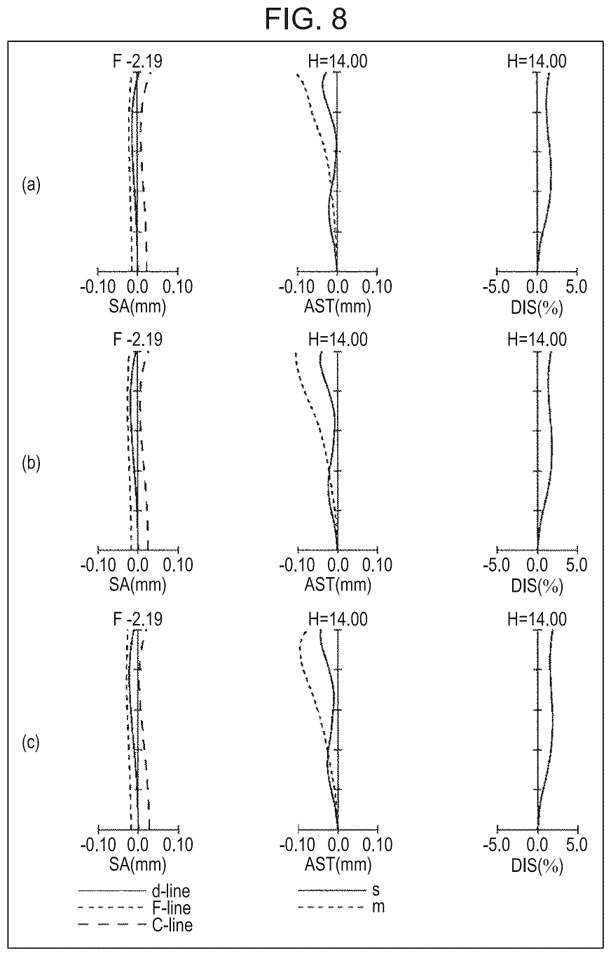

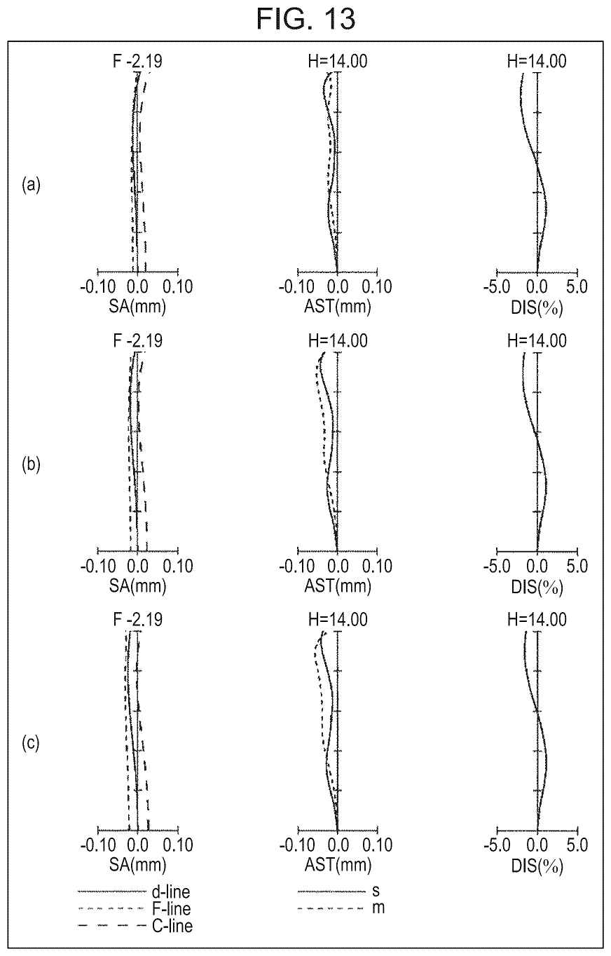

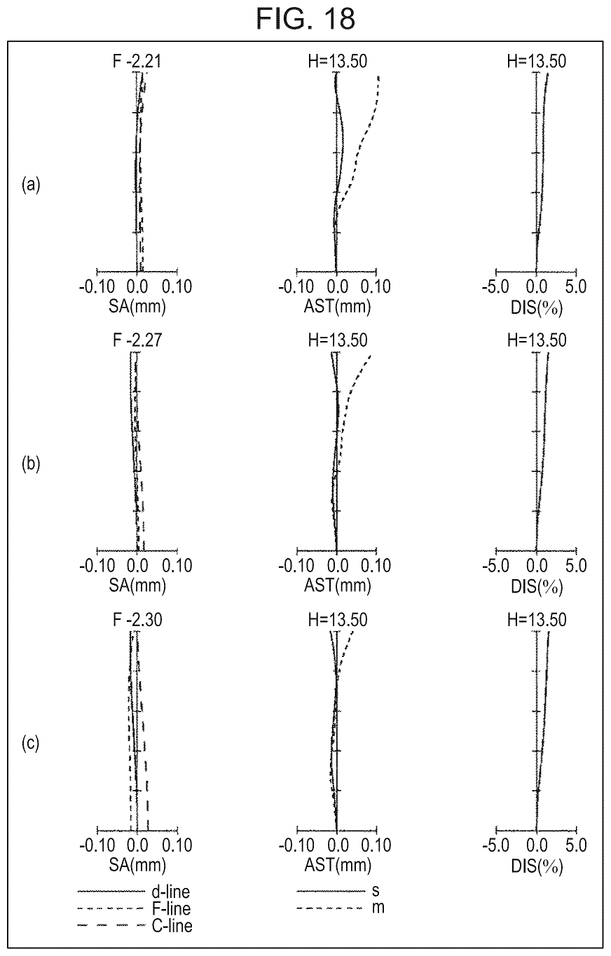

Part (a) of FIG. 3, part (a) of FIG. 8, part (a) of FIG. 13, and part (a) of FIG. 18 each illustrate a longitudinal aberration diagram at the wide angle end of the corresponding one of the zoom lens systems.

Part (b) of FIG. 3, part (b) of FIG. 8, part (b) of FIG. 13, and part (b) of FIG. 18 each illustrate a longitudinal aberration diagram at an intermediate position of the corresponding one of the zoom lens systems.

Part (c) of FIG. 3, part (c) of FIG. 8, part (c) of FIG. 13, and part (c) of FIG. 18 each illustrate a longitudinal aberration diagram at a telephoto end of the corresponding one of the zoom lens systems.

The wide angle end means a shortest focal length state where the whole system has shortest focal length absolute value |fw|. The intermediate position means an intermediate focal length state between the wide angle end and the telephoto end. The telephoto end means a longest focal length state where the whole system has longest focal length absolute value |ft|. The intermediate position has focal length fm that is defined as “fm≈−√(fw×ft)” based on focal length fw at the wide angle end and focal length ft at the telephoto end.

The zoom lens system according to Example 1 includes enlargement optical system Op, relay optical system Ol, and optical element P, and enlargement optical system Op includes first a-lens group G1a.

Relay optical system Ol includes first b-lens group G1b, and second lens group G2 to fourth lens group G4.

First lens group G1 includes first lens group G1a and first lens group G1b. Enlargement optical system Op is composed of first lens element L1 to fourteenth lens element L14 that include surface 1 to surface 28 (see numerical examples described later).

First a-lens group G1a has positive power, and is composed of first lens element L1 to fourteenth lens element L14 that include surface 1 to surface 28. Relay optical system Ol is composed of fifteenth lens element L15 to twenty-seventh lens element L27 that include surface 29 to surface 55.

First b-lens group G1b has negative power, and is composed of fifteenth lens element L15 to seventeenth lens element L17 that include surface 29 to surface 34.

Second lens group G2 has positive power, and is composed of eighteenth lens element L18 to twentieth lens element L20 that include surface 35 to surface 40.

Third lens group G3 has negative power, and is composed of twenty-first lens element L21 to twenty-fourth lens element L24 that include surface 41 to surface 49.

Fourth lens group G4 has positive power, and is composed of twenty-fifth lens element L25 to twenty-seventh lens element L27 that include surface 50 to surface 55.

The zoom lens system according to Example 2 includes enlargement optical system Op, relay optical system Ol, and optical element P, and enlargement optical system Op includes first a-lens group G1a.

Relay optical system Ol includes first b-lens group G1b, and second lens group G2 to fourth lens group G4. First lens group G1 includes first lens group G1a and first lens group G1b.

Enlargement optical system Op is composed of first lens element L1 to fourteenth lens element L14 that include surface 1 to surface 28 (see numerical examples described later).

First a-lens group G1a has positive power, and is composed of first lens element L1 to fourteenth lens element L14 that include surface 1 to surface 28.

Relay optical system Ol is composed of fifteenth lens element L15 to twenty-seventh lens element L27 that include surface 29 to surface 55.

First b-lens group G1b has negative power, and is composed of fifteenth lens element L15 to seventeenth lens element L17 that include surface 29 to surface 34.

Second lens group G2 has positive power, and is composed of eighteenth lens element L18 to twentieth lens element L20 that include surface 35 to surface 40.

Third lens group G3 has negative power, and is composed of twenty-first lens element L21 to twenty-fourth lens element L24 that include surface 41 to surface 49.

Fourth lens group G4 has positive power, and is composed of twenty-fifth lens element L25 to twenty-seventh lens element L27 that include surface 50 to surface 55.

The zoom lens system according to Example 3 includes enlargement optical system Op, relay optical system Ol, and optical element P, and enlargement optical system Op includes first a-lens group G1a.

Relay optical system Ol includes first b-lens group G1b, and second lens group G2 to fourth lens group G4.

First lens group G1 includes first lens group G1a and first lens group G1b.

Enlargement optical system Op is composed of first lens element L1 to fourteenth lens element L14 that include surface 1 to surface 28 (see numerical examples described later).

First a-lens group G1a has positive power, and is composed of first lens element L1 to fourteenth lens element L14 that include surface 1 to surface 28.

Relay optical system Ol is composed of fifteenth lens element L15 to twenty-eighth lens element L28 that include surface 29 to surface 57.

First b-lens group G1b has negative power, and is composed of fifteenth lens element L15 to eighteenth lens element L18 that include surface 29 to surface 36.

Second lens group G2 has positive power, and is composed of nineteenth lens element L19 to twenty-first lens element L21 that include surface 37 to surface 42.

Third lens group G3 has negative power, and is composed of twenty-second lens element L22 to twenty-fifth lens element L25 that include surface 43 to surface 51.

Fourth lens group G4 has positive power, and is composed of twenty-sixth lens element L26 to twenty-eighth lens element L28 that include surface 52 to surface 57.

The zoom lens system according to Example 4 includes enlargement optical system Op, relay optical system Ol, and optical element P, and enlargement optical system Op includes first lens group G1.

Relay optical system Ol includes second lens group G2 to fifth lens group G5.

Enlargement optical system Op is composed of first lens element L1 to eleventh lens element L11 that include surface 1 to surface 21 (see numerical examples described later).

First lens group G1 has positive power, and is composed of first lens element L1 to eleventh lens element L11 that include surface 1 to surface 21.

Relay optical system Ol is composed of twelfth lens element L12 to twenty-fifth lens element L25 that include surface 22 to surface 48.

Second lens group G2 has negative power, and is composed of twelfth lens element L12 to thirteenth lens element L13 that include surface 22 to surface 25.

Third lens group G3 has positive power, and is composed of fourteenth lens element L14 that includes surface 26 to surface 27.

Fourth lens group G4 has positive power, and is composed of fifteenth lens element L15 to seventeenth lens element L17 that include surface 28 to surface 32.

Fifth lens group G5 has positive power, and is composed of eighteenth lens element L18 to twenty-fifth lens element L25 that include surface 33 to surface 48.

Polygonal line arrows illustrated between part (a) and part (b) of each of FIGS. 2, 7, and 12 are straight lines obtained by connecting positions of first lens group G1 to fourth lens group G4 in respective states at the wide angle end, the intermediate position, and the telephoto end in order from above downward in the drawing. Not only the wide angle end and the intermediate position, but also the intermediate position and the telephoto end are only connected simply by a straight line, and thus being different from actual movement of each of lens groups G1 to G4. Symbols (+) and (−) attached to the reference sign of each of lens groups G1 to G4 indicate respectively positive and negative of power of each of lens groups G1 to G4.

Polygonal line arrows illustrated between part (a) and part (b) of FIG. 17 are straight lines obtained by connecting positions of first lens group G1 to fifth lens group G5 in respective states at the wide angle end, the intermediate position, and the telephoto end in order from above downward in the drawing. Not only the wide angle end and the intermediate position, but also the intermediate position and the telephoto end are only connected simply by a straight line, and thus being different from actual movement of each of lens groups G1 to G5. Symbols (+) and (−) attached to the reference sign of each of lens groups G1 to G5 indicate respectively positive and negative of power of each of lens groups G1 to G5.

The zoom lens system in each of FIGS. 1, 6, 11 includes focusing adjustment lens group FG1 that performs focus adjustment when an object distance changes, and image plane curvature correction lens group FG2 that corrects image plane curvature aberration after focusing adjustment lens group FG1 performs the focus adjustment.

The zoom lens system in FIG. 16 includes focusing adjustment lens group FG1 that performs focus adjustment when an object distance changes.

Focusing adjustment lens group FG1 in each of FIGS. 1 and 6 is composed of fifteenth lens element L15 and sixteenth lens element L16 in order from the enlargement side toward the reduction side.

Image plane curvature correction lens group FG2 is composed of first lens element L1 to tenth lens element L10.

Focusing adjustment lens group FG1 in FIG. 11 is composed of fifteenth lens element L15 and seventeenth lens element L17 in order from the enlargement side toward the reduction side.

Image plane curvature correction lens group FG2 is composed of first lens element L1 to tenth lens element L10.

Focusing adjustment lens group FG1 in FIG. 16 is composed of twelfth lens element L12 and thirteenth lens element L13 in order from the enlargement side toward the reduction side. During focusing, focusing adjustment lens group FG1 is movable along the optical axis. Focusing adjustment lens group FG1 moves toward the enlargement side when moving from a side with a long projection distance toward a side with a short projection distance.

When the image plane curvature aberration at the enlargement conjugate point on the enlargement side is corrected, image plane curvature correction lens group FG2 is movable along the optical axis. Image plane curvature correction lens group FG2 in each of FIGS. 1, 6, and 11 moves toward the enlargement side when moving from a side with a long projection distance toward a side with a short projection distance.

Each drawing shows an image forming position (or the enlargement conjugate point) on the enlargement side on the left side, and an image forming position (or the reduction conjugate point) on the reduction side on the right side. Each drawing also illustrates a straight line on the most reduction side, the straight line representing a position of original image S, and optical element P that is located on the enlargement side of original image S. Optical element P represents an optical element such as a prism for color separation and color synthesis, an optical filter, a parallel plate glass, a quartz low-pass filter, or an infrared cut filter.

The zoom lens system according to each of Examples 1 to 4 includes an intermediate image forming position MI that is conjugate with each of the enlargement conjugate point on the enlargement side and the reduction conjugate point on the reduction side. Each drawing illustrates enlargement optical system Op that is disposed on the enlargement side from intermediate image forming position MI, and relay optical system Ol that is disposed on the reduction side from intermediate image forming position MI.

Part (a) of FIG. 3 is a longitudinal aberration diagram of the zoom lens system according to Example 1 at the wide angle end at the object distance of 979.4417 mm.

Part (b) of FIG. 3 is a longitudinal aberration diagram of the zoom lens system according to Example 1 at an intermediate position at an object distance of 1014.6519 mm.

Part (c) of FIG. 3 is a longitudinal aberration diagram of the zoom lens system according to Example 1 at a telephoto end at an object distance of 1048.7004 mm.

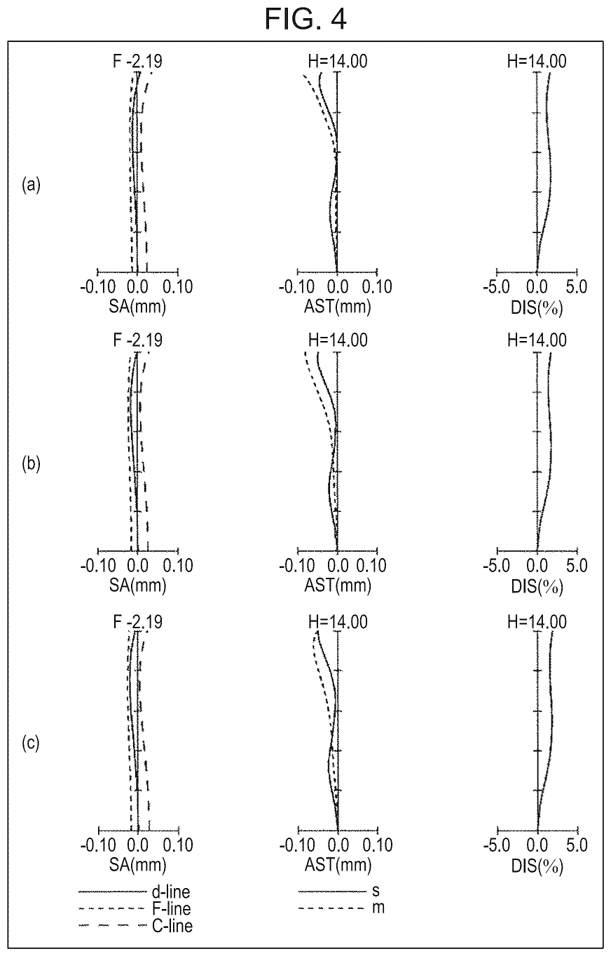

Part (a) of FIG. 4 is a longitudinal aberration diagram of the zoom lens system according to Example 1 at a wide angle end at an object distance of 640.2217 mm.

Part (b) of FIG. 4 is a longitudinal aberration diagram of the zoom lens system according to Example 1 at an intermediate position at an object distance of 662.9035 mm.

Part (c) of FIG. 4 is a longitudinal aberration diagram of the zoom lens system according to Example 1 at a telephoto end at an object distance of 686.3889 mm.

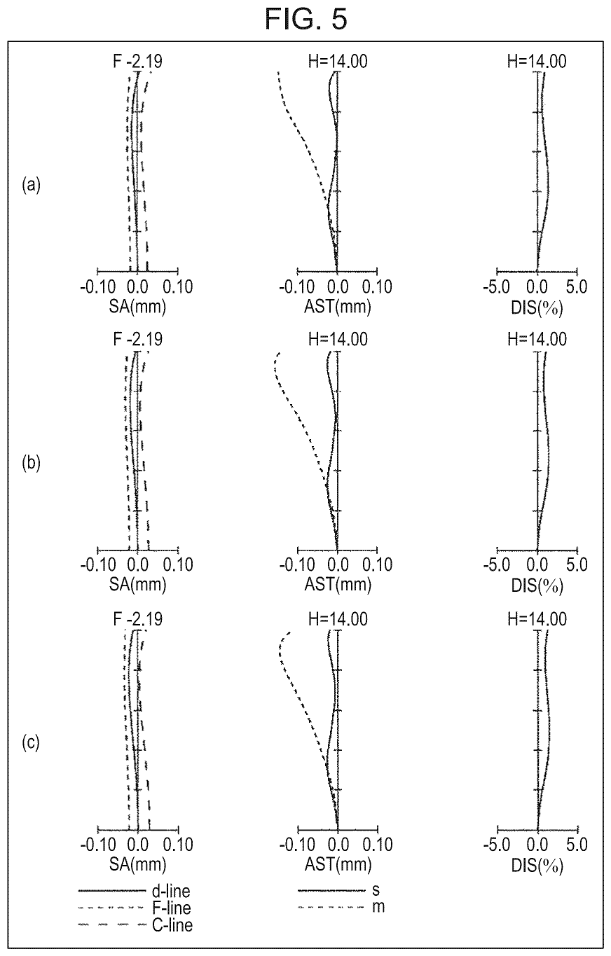

Part (a) of FIG. 5 is a longitudinal aberration diagram of the zoom lens system according to Example 1 at a wide angle end at an object distance of 6746.9034 mm.

Part (b) of FIG. 5 is a longitudinal aberration diagram of the zoom lens system according to Example 1 at an intermediate position at an object distance of 6974.4484 mm.

Part (c) of FIG. 5 is a longitudinal aberration diagram of the zoom lens system according to Example 1 at a telephoto end at an object distance of 7209.6675 mm.

Part (a) of FIG. 8 is a longitudinal aberration diagram of the zoom lens system according to Example 2 at a wide angle end at an object distance of 982.2430 mm.

Part (b) of FIG. 8 is a longitudinal aberration diagram of the zoom lens system according to Example 2 at an intermediate position at an object distance of 1016.5500 mm.

Part (c) of FIG. 8 is a longitudinal aberration diagram of the zoom lens system according to Example 2 at a telephoto end at an object distance of 1051.6500 mm.

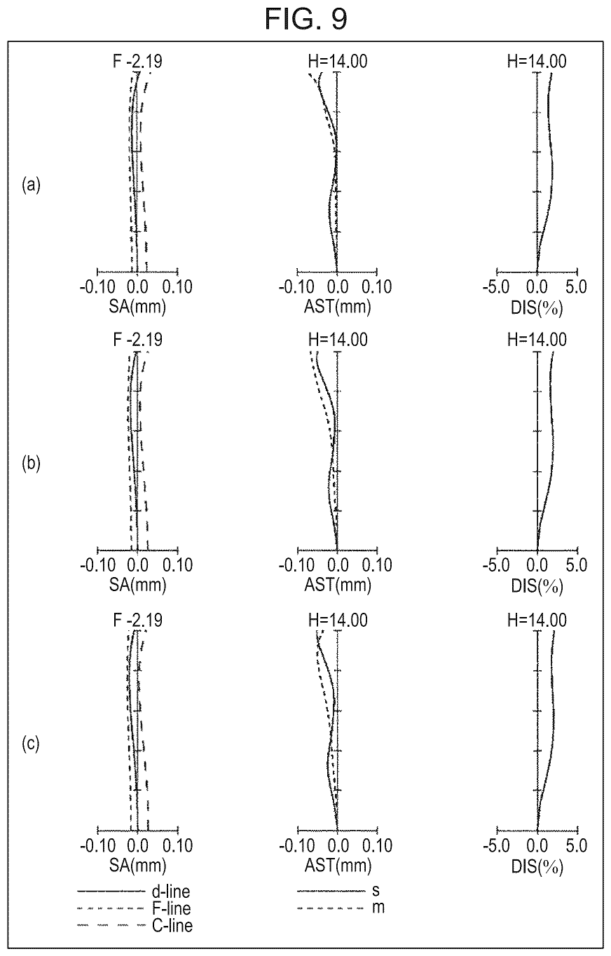

Part (a) of FIG. 9 is a longitudinal aberration diagram of the zoom lens system according to Example 2 at a wide angle end at an object distance of 648.9340 mm.

Part (b) of FIG. 9 is a longitudinal aberration diagram of the zoom lens system according to Example 2 at an intermediate position at an object distance of 668.3514 mm.

Part (c) of FIG. 9 is a longitudinal aberration diagram of the zoom lens system according to Example 2 at a telephoto end at an object distance of 688.3500 mm.

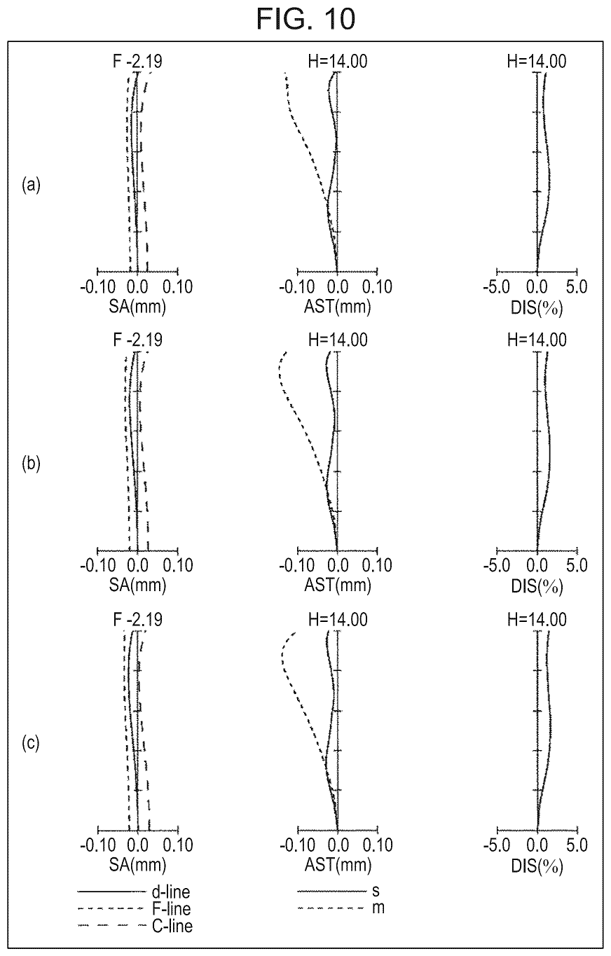

Part (a) of FIG. 10 is a longitudinal aberration diagram of the zoom lens system according to Example 2 at a wide angle end at an object distance of 6838.0200 mm.

Part (b) of FIG. 10 is a longitudinal aberration diagram of the zoom lens system according to Example 2 at an intermediate position at an object distance of 7032.3438 mm.

Part (c) of FIG. 10 is a longitudinal aberration diagram of the zoom lens system according to Example 2 at a telephoto end at an object distance of 7232.1900 mm.

Part (a) of FIG. 13 is a longitudinal aberration diagram of the zoom lens system according to Example 3 at a wide angle end at an object distance of 982.2430 mm.

Part (b) of FIG. 13 is a longitudinal aberration diagram of the zoom lens system according to Example 3 at an intermediate position at an object distance of 1016.5500 mm.

Part (c) of FIG. 13 is a longitudinal aberration diagram of the zoom lens system according to Example 3 at a telephoto end at an object distance of 1051.6500 mm.

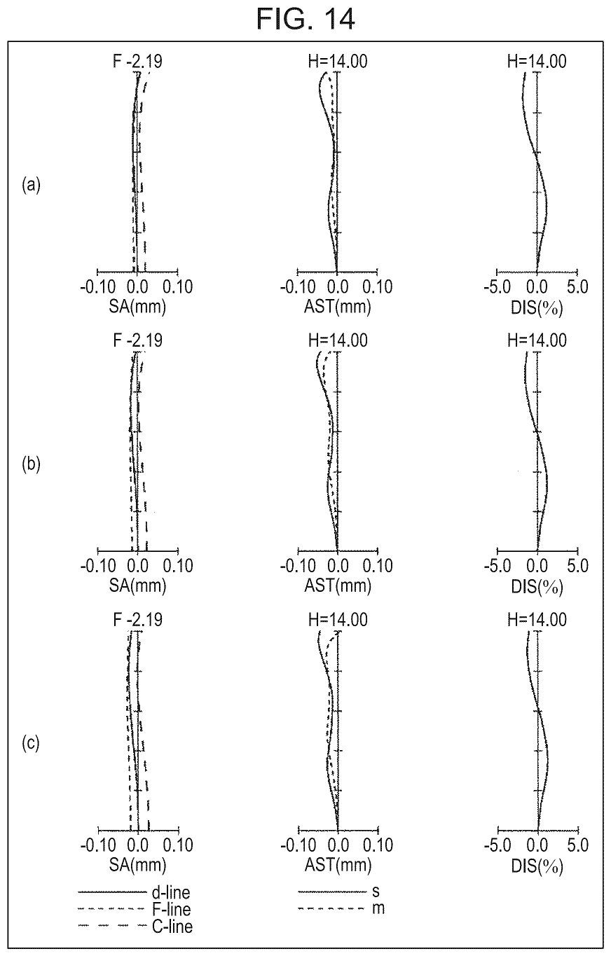

Part (a) of FIG. 14 is a longitudinal aberration diagram of the zoom lens system according to Example 3 at a wide angle end at an object distance of 648.9340 mm.

Part (b) of FIG. 14 is a longitudinal aberration diagram of the zoom lens system according to Example 3 at an intermediate position at an object distance of 668.3514 mm.

Part (c) of FIG. 14 is a longitudinal aberration diagram of the zoom lens system according to Example 3 at a telephoto end at an object distance of 688.3500 mm.

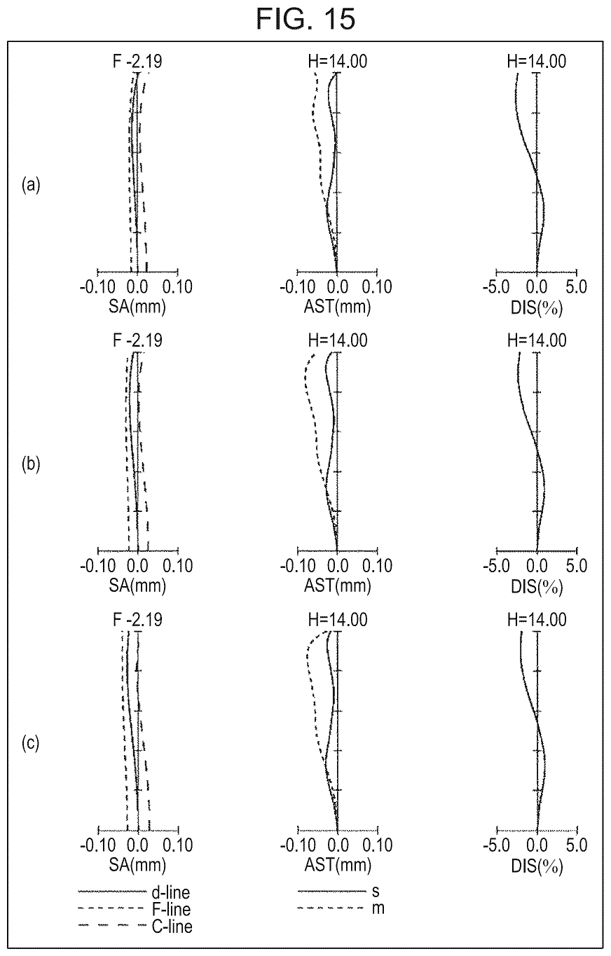

Part (a) of FIG. 15 is a longitudinal aberration diagram of the zoom lens system according to Example 3 at a wide angle end at an object distance of 6838.0200 mm.

Part (b) of FIG. 15 is a longitudinal aberration diagram of the zoom lens system according to Example 3 at an intermediate position at an object distance of 7032.3438 mm.

Part (c) of FIG. 15 is a longitudinal aberration diagram of the zoom lens system according to Example 3 at a telephoto end at an object distance of 7232.1900 mm.

Part (a) of FIG. 18 is a longitudinal aberration diagram of the zoom lens system according to Example 4 at a wide angle end at an object distance of 1780.3701 mm.

Part (b) of FIG. 18 is a longitudinal aberration diagram of the zoom lens system according to Example 4 at an intermediate position at an object distance of 2027.5398 mm.

Part (c) of FIG. 18 is a longitudinal aberration diagram of the zoom lens system according to Example 4 at a telephoto end at an object distance of 2204.3709 mm.

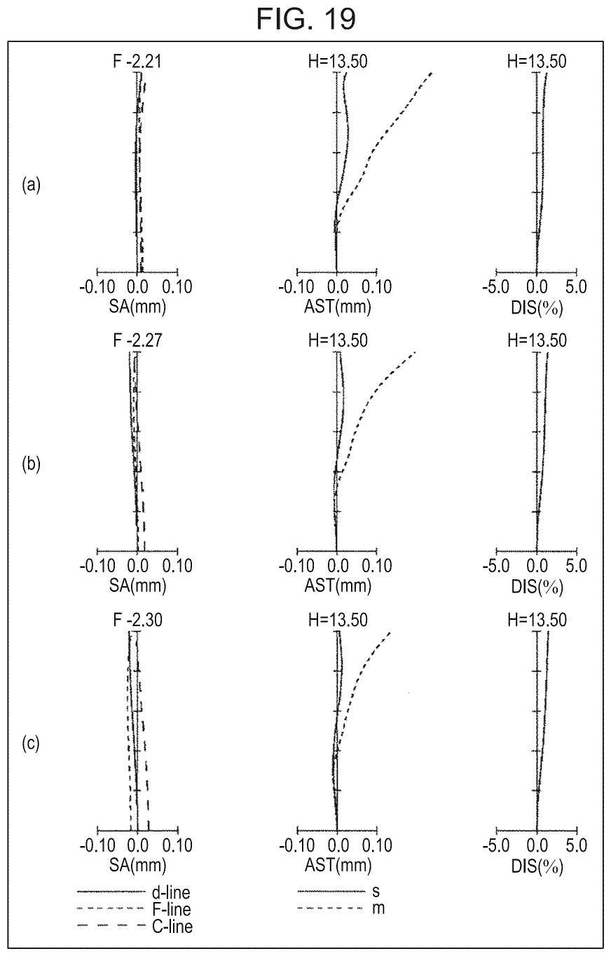

Part (a) of FIG. 19 is a longitudinal aberration diagram of the zoom lens system according to Example 4 at a wide angle end at an object distance of 1177.3665 mm.

Part (b) of FIG. 19 is a longitudinal aberration diagram of the zoom lens system according to Example 4 at an intermediate position at an object distance of 1342.3017 mm.

Part (c) of FIG. 19 is a longitudinal aberration diagram of the zoom lens system according to Example 4 at a telephoto end at an object distance of 1460.3135 mm.

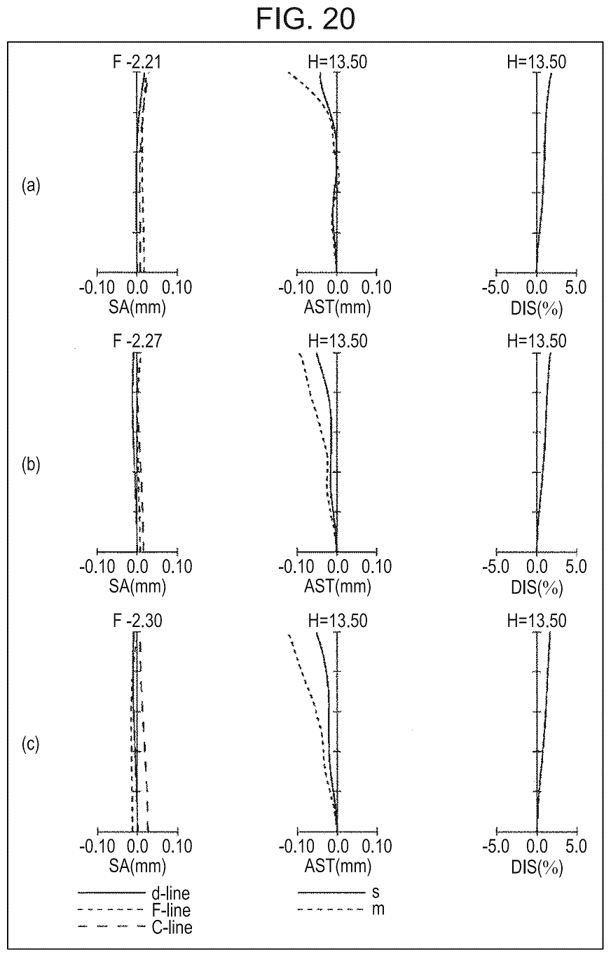

Part (a) of FIG. 20 is a longitudinal aberration diagram of the zoom lens system according to Example 4 at a wide angle end at an object distance of 12031.5570 mm.

Part (b) of FIG. 20 is a longitudinal aberration diagram of the zoom lens system according to Example 4 at an intermediate position at an object distance of 13676.7250 mm.

Part (c) of FIG. 20 is a longitudinal aberration diagram of the zoom lens system according to Example 4 at a telephoto end at an object distance of 14853.4950 mm.

Each of the longitudinal aberration diagrams illustrates spherical aberration (SA (mm)), astigmatism (AST (mm)), and distortion (DIS (%)) in order from the left side. The spherical aberration diagram shows a vertical axis represents a height of a pupil, a solid line representing a characteristic of a d-line, a short broken line representing a characteristic of an F-line, and a long broken line representing a characteristic of a C-line. The astigmatism diagram shows a vertical axis representing an image height, a solid line representing a characteristic of a sagittal plane (denoted by “s” in the drawing), and a broken line representing a characteristic of a meridional plane (denoted by “m” in the drawing). The distortion diagram shows a vertical axis representing an image height. The distortion represents distortion with respect to equidistant projection.

### Example 1

As illustrated in FIGS. 1 and 2, the zoom lens system according to Example 1 includes enlargement optical system Op and relay optical system Ol.

Enlargement optical system Op is composed of first lens element L1 to fourteenth lens element L14 in order from the enlargement side toward the reduction side. First lens element L1 has a negative meniscus shape with a convex surface facing the enlargement side. Second lens element L2 has a positive meniscus shape with a convex surface facing the enlargement side. Third lens element L3 has a negative meniscus shape with a convex surface facing the enlargement side. Fourth lens element L4 has a negative meniscus shape with a convex surface facing the enlargement side. Fifth lens element L5 has a positive meniscus shape with a convex surface facing the enlargement side. Sixth lens element L6 has a negative meniscus shape with a convex surface facing the reduction side. Seventh lens element L7 has a biconvex shape. Eighth lens element L8 has a biconvex shape. Ninth lens element L9 has a negative meniscus shape with a convex surface facing the enlargement side. Tenth lens element L10 has a positive meniscus shape with a convex surface facing the reduction side. Eleventh lens element L11 has a negative meniscus shape with a convex surface facing the reduction side. Twelfth lens element L12 has a positive meniscus shape with a convex surface facing the enlargement side. Thirteenth lens element L13 has a positive meniscus shape with a convex surface facing the enlargement side. Fourteenth lens element L14 has a positive meniscus shape with a convex surface facing the enlargement side.

Relay optical system Ol is composed of fifteenth lens element L15 to twenty-seventh lens element L27 in order from the enlargement side toward the reduction side. Fifteenth lens element L15 has a biconcave shape.

Sixteenth lens element L16 has a biconcave shape. Seventeenth lens element L17 has a positive meniscus shape with a convex surface facing the reduction side. Eighteenth lens element L18 has a biconvex shape. Nineteenth lens element L19 has a biconcave shape. Twentieth lens element L20 has a biconvex shape. Twenty-first lens element L21 has a positive meniscus shape with a convex surface facing the enlargement side. Twenty-second lens element L22 has a negative meniscus shape with a convex surface facing the enlargement side. Twenty-third lens element L23 has a biconcave shape. Twenty-fourth lens element L24 has a biconvex shape. Twenty-fifth lens element L25 has a biconvex shape. Twenty-sixth lens element L26 has a negative meniscus shape with a convex surface facing the enlargement side. Twenty-seventh lens element L27 has a biconvex shape.

Relay optical system Ol is composed of a first b-lens group (L15 to L17) having negative power, a second lens group (L18 to L20) having positive power, a third lens group (L21 to L24) having negative power, and a fourth lens group (L25 to L27) having positive power, in order from the enlargement side toward the reduction side.

The second lens group and the fourth lens group in relay optical system Ol are displaced toward the enlargement side along the optical axis during zooming from the wide angle end to the telephoto end.

The zoom lens system according to Example 1 includes intermediate image forming position MI located between fourteenth lens element L14 and fifteenth lens element L15.

Relay optical system Ol includes diaphragm A disposed between twenty-first lens element L21 and twenty-second lens element L22.

Relay optical system Ol also includes optical element P having optical power of zero disposed on the reduction side.

### Example 2

As illustrated in FIGS. 6 and 7, the zoom lens system according to Example 2 includes enlargement optical system Op and relay optical system Ol.

Enlargement optical system Op is composed of first lens element L1 to fourteenth lens element L14 in order from the enlargement side toward the reduction side. First lens element L1 has a negative meniscus shape with a convex surface facing the enlargement side. Second lens element L2 has a positive meniscus shape with a convex surface facing the enlargement side. Third lens element L3 has a negative meniscus shape with a convex surface facing the enlargement side. Fourth lens element L4 has a negative meniscus shape with a convex surface facing the enlargement side. Fifth lens element L5 has a positive meniscus shape with a convex surface facing the enlargement side. Sixth lens element L6 has a negative meniscus shape with a convex surface facing the reduction side. Seventh lens element L7 has a biconvex shape. Eighth lens element L8 has a biconvex shape. Ninth lens element L9 has a biconcave shape. Tenth lens element L10 has a biconvex shape. Eleventh lens element L11 has a biconcave shape. Twelfth lens element L12 has a positive meniscus shape with a convex surface facing the enlargement side. Thirteenth lens element L13 has a biconvex shape. Fourteenth lens element L14 has a positive meniscus shape with a convex surface facing the enlargement side.

Relay optical system Ol is composed of fifteenth lens element L15 to twenty-seventh lens element L27 in order from the enlargement side toward the reduction side. Fifteenth lens element L15 has a biconcave shape. Sixteenth lens element L16 has a biconcave shape. Seventeenth lens element L17 has a positive meniscus shape with a convex surface facing the reduction side. Eighteenth lens element L18 has a biconvex shape. Nineteenth lens element L19 has a biconcave shape. Twentieth lens element L20 has a biconvex shape. Twenty-first lens element L21 has a positive meniscus shape with a convex surface facing the enlargement side. Twenty-second lens element L22 has a negative meniscus shape with a convex surface facing the enlargement side. Twenty-third lens element L23 has a biconcave shape. Twenty-fourth lens element L24 has a biconvex shape. Twenty-fifth lens element L25 has a biconvex shape. Twenty-sixth lens element L26 has a negative meniscus shape with a convex surface facing the enlargement side. Twenty-seventh lens element L27 has a biconvex shape.

Relay optical system Ol is composed of a first b-lens group (L15 to L17) having negative power, a second lens group (L18 to L20) having positive power, a third lens group (L21 to L24) having negative power, and a fourth lens group (L25 to L27) having positive power, in order from the enlargement side toward the reduction side.

The second lens group and the fourth lens group in relay optical system Ol are displaced toward the enlargement side along the optical axis during zooming from the wide angle end to the telephoto end.

The zoom lens system according to Example 2 includes intermediate image forming position MI located between fourteenth lens element L14 and fifteenth lens element L15. Relay optical system Ol includes diaphragm A disposed between twenty-first lens element L21 and twenty-second lens element L22. Relay optical system Ol also includes optical element P having optical power of zero disposed on the reduction side.

### Example 3

As illustrated in FIGS. 11 and 12, the zoom lens system according to Example 3 includes enlargement optical system Op and relay optical system Ol.

Enlargement optical system Op is composed of first lens element L1 to fourteenth lens element L14 in order from the enlargement side toward the reduction side. First lens element L1 has a negative meniscus shape with a convex surface facing the enlargement side.

Second lens element L2 has a positive meniscus shape with a convex surface facing the enlargement side. Third lens element L3 has a negative meniscus shape with a convex surface facing the enlargement side. Fourth lens element L4 has a negative meniscus shape with a convex surface facing the enlargement side. Fifth lens element L5 has a positive meniscus shape with a convex surface facing the enlargement side. Sixth lens element L6 has a negative meniscus shape with a convex surface facing the reduction side. Seventh lens element L7 has a biconvex shape. Eighth lens element L8 has a biconvex shape. Ninth lens element L9 has a biconcave shape. Tenth lens element L10 has a biconvex shape. Eleventh lens element L11 has a biconcave shape. Twelfth lens element L12 has a positive meniscus shape with a convex surface facing the reduction side. Thirteenth lens element L13 has a biconvex shape. Fourteenth lens element L14 has a positive meniscus shape with a convex surface facing the enlargement side.

Relay optical system Ol is composed of fifteenth lens element L15 to twenty-eighth lens element L28 in order from the enlargement side toward the reduction side. Fifteenth lens element L15 has a biconcave shape. Sixteenth lens element L16 has a positive meniscus shape with a convex surface facing the enlargement side. Seventeenth lens element L17 has a negative meniscus shape with a convex surface facing the enlargement side. Eighteenth lens element L18 has a positive meniscus shape with a convex surface facing the reduction side. Nineteenth lens element L19 has a biconvex shape. Twentieth lens element L20 has a biconcave shape. Twenty-first lens element L21 has a biconvex shape. Twenty-second lens element L22 has a positive meniscus shape with a convex surface facing the enlargement side. Twenty-third lens element L23 has a negative meniscus shape with a convex surface facing the enlargement side. Twenty-fourth lens element L24 has a biconcave shape. Twenty-fifth lens element L25 has a biconvex shape. Twenty-sixth lens element L26 has a biconvex shape. Twenty-seventh lens element L27 has a negative meniscus shape with a convex surface facing the enlargement side. Twenty-eighth lens element L28 has a biconvex shape.

Relay optical system Ol is composed of a first b-lens group (L15 to L18) having negative power, a second lens group (L19 to L21) having positive power, a third lens group (L22 to L25) having negative power, and a fourth lens group (L26 to L28) having positive power, in order from the enlargement side toward the reduction side.

The second lens group and the fourth lens group in relay optical system Ol are displaced toward the enlargement side along the optical axis during zooming from the wide angle end to the telephoto end.

The zoom lens system according to Example 3 includes intermediate image forming position MI located between fourteenth lens element L14 and fifteenth lens element L15.

Relay optical system Ol includes diaphragm A disposed between twenty-second lens element L22 and twenty-third lens element L23.

Relay optical system Ol also includes optical element P having optical power of zero disposed on the reduction side.

### Example 4

As illustrated in FIGS. 16 and 17, the zoom lens system according to Example 4 includes enlargement optical system Op and relay optical system Ol.

Enlargement optical system Op is composed of first lens element L1 to eleventh lens element L11 in order from the enlargement side to the reduction side. First lens element L1 has a positive meniscus shape with a convex surface facing the enlargement side. Second lens element L2 has a negative meniscus shape with a convex surface facing the enlargement side. Third lens element L3 has a negative meniscus shape with a convex surface facing the enlargement side. Fourth lens element L4 has a biconvex shape. Fifth lens element L5 has a biconcave shape. Sixth lens element L6 has a biconvex shape. Seventh lens element L7 has a biconcave shape. Eighth lens element L8 has a biconvex shape. Ninth lens element L9 has a positive meniscus shape with a convex surface facing the reduction side. Tenth lens element L10 has a positive meniscus shape with a convex surface facing the enlargement side. Eleventh lens element L11 has a positive meniscus shape with a convex surface facing the enlargement side.

Fifth lens element L5 and sixth lens element L6 are bonded to each other with an adhesive material such as an ultraviolet curable resin, for example, to constitute a cemented lens.

Relay optical system Ol is composed of twelfth lens element L12 to twenty-fifth lens element L25 in order from the enlargement side toward the reduction side. Twelfth lens element L12 has a biconcave shape. Thirteenth lens element L13 has a biconcave shape. Fourteenth lens element L14 has a positive meniscus shape with a convex surface facing the reduction side. Fifteenth lens element L15 has a biconvex shape. Sixteenth lens element L16 has a biconcave shape. Seventeenth lens element L17 has a biconvex shape. Eighteenth lens element L18 has a positive meniscus shape with a convex surface facing the enlargement side. Nineteenth lens element L19 has a biconcave shape. Twentieth lens element L20 has a biconcave shape. Twenty-first lens element L21 has a positive meniscus shape with a convex surface facing the reduction side. Twenty-second lens element L22 has a biconvex shape. Twenty-third lens element L23 has a negative meniscus shape with a convex surface facing the enlargement side. Twenty-fourth lens element L24 has a biconvex shape. Twenty-fifth lens element L25 has a positive meniscus shape with a convex surface facing the enlargement side. Sixteenth lens element L16 and seventeenth lens element L17 are bonded to each other with an adhesive material such as an ultraviolet curable resin, for example, to constitute a cemented lens.

Twenty-third lens element L23 and twenty-fourth lens element L24 are bonded to each other with an adhesive material such as an ultraviolet curable resin, for example, to constitute a cemented lens.

Relay optical system Ol is composed of a second lens group (L12 to L13) having negative power, a third lens group (L14) having positive power, a fourth lens group (L15 to L17) having positive power, and a fifth lens group (L18 to L25) having positive power, in order from the enlargement side toward the reduction side.

The second lens group, the third lens group, the fourth lens group, and the fifth lens group in relay optical system Ol are displaced toward the enlargement side along the optical axis during zooming from the wide angle end to the telephoto end.

The zoom lens system according to Example 4 includes intermediate image forming position MI located between eleventh lens element L11 and twelfth lens element L12.

Relay optical system Ol includes diaphragm A disposed between eighteenth lens element L18 and nineteenth lens element L19. Relay optical system Ol also includes optical element P having optical power of zero disposed on the reduction side.

The zoom lens system according to each of Examples 1 to 4 may include not only a lens element having optical power but also an element having optical power of zero or substantially zero, for example, an optical element such as a mirror, a diaphragm, a mask, a cover glass, a filter, a prism, a wave plate, or a polarizing element.

Next, conditions that can be satisfied by the zoom lens system according to the present exemplary embodiment will be described. Although a plurality of conditions is defined for the zoom lens system according to each Example, all of the plurality of conditions may be satisfied, or corresponding effects can be obtained by satisfying individual conditions.

The zoom lens system according to each of Examples 1 to 4 is an optical system including an intermediate image forming position inside the optical system, the intermediate image forming position being conjugate with each of an enlargement conjugate point on an enlargement side and a reduction conjugate point on a reduction side, the optical system including: an enlargement optical system located closer to the enlargement side than the intermediate image forming position; and a relay optical system located closer to the reduction side than the intermediate image forming position, the relay optical system including: a positive lens element disposed on a most reduction side; and a focusing lens group on a most enlargement side that moves in an optical axis direction during focusing, the focusing lens group including two negative lens elements having negative power.

This configuration enables a lens to be reduced in effective diameter even when the lens has a wide angle, so that the lens can be reduced in weight. This configuration also enables an operative mechanism for zooming to be simply configured, so that mechanical components can be reduced in weight, and thus the entire lens can be reduced in weight. Additionally, a principal point position can be disposed on the enlargement side, so that an overall optical length can be shortened. This configuration is also effective in correcting distortion. Then, the optical system has a shape concentric with intermediate image forming position MI, and thus being effective in correcting distortion and image plane curvature. The optical system is also facilitated to ensure telecentric property, so that color unevenness of a projection image due to optical thin film characteristics of optical element P, such as a prism, disposed in front of a display element can be prevented from occurring. This configuration also enables favorably reducing change in image plane curvature and in distortion due to focusing.

The zoom lens system according to each of Examples 1 to 4 includes ten or more lens elements including a positive lens element and two negative lens elements. This configuration enables various aberrations such as spherical aberration, coma aberration, astigmatism, chromatic aberration, image plane curvature, and distortion to be favorably corrected, and thus enables high image quality.

The zoom lens system according to each of Examples 1 to 3 includes negative lens element L1 disposed on the most enlargement side of enlargement optical system Op. This configuration enables reducing an effective diameter of a lens on the most enlargement side where enlargement is inevitable particularly in a wide-angle lens, so that the lens can be reduced in weight, and excessive deviation of lens centroid to the enlargement side can be prevented.

The zoom lens system according to each of Examples 1 to 4 includes a lens element disposed on the most enlargement side among a plurality of lens elements constituting focusing lens group Fg1, the lens element having a concave surface facing the enlargement side. This configuration enables various aberrations such as astigmatism, image plane curvature, and distortion to be favorably corrected, and thus enables high image quality.

The zoom lens system according to each of Examples 1 to 4 includes a lens element disposed on the most enlargement side among a plurality of lens elements constituting focusing lens group Fg1, the lens element having negative power. This configuration enables various aberrations such as astigmatism, image plane curvature, and distortion to be favorably corrected, and thus enables high image quality.

The zoom lens system according to each of Examples 1 to 4 does not include a reflective surface having power in the optical system. This configuration enables eliminating the reflective surface having power with high manufacturing error sensitivity in particular, and thus enables high image quality.

The zoom lens system according to each of Examples 1 to 4 does not include a reflecting surface in the optical system. This configuration enables eliminating the reflective surface with high manufacturing error sensitivity in particular, and thus enables high image quality.

The zoom lens system according to each of Examples 1 to 4 includes focusing lens group Fg1 composed of three or less lens elements including two negative lens elements. This configuration enables satisfactorily correcting various aberrations such as astigmatism, image plane curvature, and distortion while avoiding an increase in size due to an increase in the number of lenses, and thus enables high image quality.

The zoom lens system according to each of Examples 1 to 4 includes focusing lens group Fg1 composed of two negative lens elements. This configuration enables satisfactorily correcting various aberrations such as astigmatism, image plane curvature, and distortion while further avoiding an increase in size due to an increase in the number of lenses, and thus enables high image quality.

The zoom lens system according to each of Examples 1 to 4 includes lens element L1 disposed on the most enlargement side of enlargement optical system Op, lens element L1 being fixed during zooming. This configuration enables the operative mechanism for zooming to be simply configured, so that mechanical components can be downsized to enable downsizing of the entire lens.

The zoom lens system according to each of Examples 1 to 4 may satisfy Condition (1).

$$0.65 < \vert dn / fFg 1 \vert < 2.29 \qquad ( 1 )$$

Here, dn is a maximum value of a distance on the optical axis between two negative lens elements Ln, and fFg1 is a focal distance of focusing lens group Fg1.

Condition (1) is a conditional expression that defines a maximum value of distance dn on the optical axis between two negative lens elements Ln, and focal length fFg1 of focusing lens group Fg1. Satisfying Condition (1) enables suppressing change in image plane curvature and change in distortion due to focusing, and thus enables implementing an optical system having good optical performance for a wide projection distance range.

When the ratio falls to below the lower limit value of Condition (1), aberration correction capability of focusing lens group Fg1 deteriorates to cause difficulty in acquiring high image quality. In contrast, when the ratio exceeds the upper limit value, a distance in the optical axis direction of focusing lens group Fg1 excessively increases to result in increasing size and weight of the lens.

Satisfying preferably any one of Conditions (1a), (1b) below enables the effect described above to be more successfully provided.

$$1. < \vert dn / fFg 1 \vert \qquad ( 1 a )$$

$$\vert dn / fFg 1 \vert < 2.04 \qquad ( 1 b )$$

Satisfying more preferably any one of Conditions (1c), (1d) below enables the effect described above to be further successfully provided.

$$1.3 < \vert dn / fFg 1 \vert \qquad ( 1 c )$$

$$\vert dn / fFg 1 \vert < 1.96 \qquad ( 1 d )$$

The zoom lens system according to each of Examples 1 to 4 may satisfy Condition (2).

$$1.63 < \vert BF 2 / fw \vert < 10.58 \qquad Expression ( 2 )$$

Here, BF2 is a minimum value of an air conversion length on the d-line from a positive lens element on the most reduction side to a display element, and fw is a focal length of the entire system at a wide angle end.

Condition (2) is a conditional expression that defines minimum value BF2 of the air conversion length on the d-line from the positive lens element on the most reduction side to the display element and focal length fw of the entire system at the wide angle end.

When the ratio falls to below the lower limit of Condition (2), optical element P, such as a prism, to be disposed in front of the display element is less likely to be disposed. When the ratio exceeds the upper limit of Condition (2), a total length of the lens increases to cause difficulty in miniaturizing the entire lens. Additionally, an effective diameter of the lens on the most enlargement side excessively increases to result in increasing weight of the lens.

Satisfying preferably any one of Conditions (2a), (2b) below enables the effect described above to be more successfully provided.

$$3.13 < \vert BF 2 / fw \vert \qquad ( 2 a )$$

$$\vert BF 2 / fw \vert < 9.08 \qquad ( 2 b )$$

Satisfying more preferably any one of Conditions (2c), (2d) below enables the effect described above to be further successfully provided.

$$3.63 < \vert BF 2 / fw \vert \qquad ( 2 c )$$

$$\vert BF 2 / fw \vert < 8.58 \qquad ( 2 d )$$

The zoom lens system according to each of Examples 1 to 4 may satisfy Condition (3).

$$\vert ω \vert > 30 ° \qquad Expression ( 3 )$$

Here, ω is a maximum half angle of view at a wide angle end.

Condition (3) is a conditional expression that defines a maximum half angle of view w at a wide angle end. Satisfying Condition (3) enables implementing an optical system having a small lens diameter while having a wide angle.

When ω falls to below the lower limit of Condition (3), an angle of view at the wide angle end decreases to cause difficulty in achieving large screen projection at a short distance.

Satisfying preferably Condition (3a) below enables the effect described above to be more successfully provided.

$$45 ° < \vert ω \vert \qquad ( 3 a )$$

Satisfying more preferably Condition (3b) below enables the effect described above to be further successfully provided.

$$54 ° < \vert ω \vert \qquad ( 3 b )$$

The zoom lens system according to each of Examples 1 to 4 may satisfy Condition (4).

$$0.23 < Tp / Tr < 1.11 \qquad Expression ( 4 )$$

Here, Tp is a distance from a surface on the most enlargement side of enlargement optical system Op to surface MIp on the most reduction side, and Tr is a distance from surface MIr on the most enlargement side of relay optical system Ol to a surface on the most reduction side of relay optical system Ol at a wide angle end.

Condition (4) is a conditional expression that defines a relationship between a distance from the surface on the most enlargement side of enlargement optical system Op to surface MIp on the most reduction side and a distance from surface MIr on the most enlargement side of relay optical system Ol at a wide angle end to the surface on the most reduction side of relay optical system Ol.

When the ratio exceeds the upper limit of Condition (4), a total length of enlargement optical system Op increases to cause difficulty in miniaturizing the entire lens. When the ratio falls to below the lower limit of Condition (4), image plane curvature is less likely to be corrected.

Satisfying preferably any one of Conditions (4a), (4b) below enables the effect described above to be more successfully provided.

$$0.38 < Tp / Tr \qquad ( 4 a )$$

$$Tp / Tr < 0.96 \qquad ( 4 b )$$

Satisfying more preferably any one of Conditions (4c), (4d) below enables the effect described above to be further successfully provided.

$$0.43 < Tp / Tr \qquad ( 4 c )$$

$$Tp / Tr < 0.91 \qquad ( 4 d )$$

The zoom lens system according to each of Examples 1 to 4 may satisfy Condition (5).

$$0.16 < fp / fr < 0.75 \qquad Expression ( 5 )$$

Condition (5) is a conditional expression that defines a relationship between focal length fp of enlargement optical system Op at a wide angle end and focal length fr of relay optical system Ol at a wide angle end. Satisfying Condition (5) enables implementing an optical system having a small lens diameter while having a wide angle.

When the ratio falls to below the lower limit value of Conditional Expression (5), an effective diameter of a lens element adjacent to intermediate image forming position MI on the enlargement side excessively increases to result in increasing size and weight of the lens. Conversely, when the ratio exceeds the upper limit value, an effective diameter of lens element L1 on the most enlargement side excessively increases to result in increasing size and weight of the lens.

Satisfying preferably any one of Conditions (5a), (5b) below enables the effect described above to be more successfully provided.

$$0.26 < fp / fr \qquad ( 5 a )$$

$$fp / fr < 0.65 \qquad ( 5 b )$$

Satisfying more preferably any one of Conditions (5c), (5d) below enables the effect described above to be further successfully provided.

$$0.29 < fp / fr \qquad ( 5 c )$$

$$fp / fr < 0.62 \qquad ( 5 d )$$

As described above, some Examples have been described as examples of the technique disclosed in the present application. The technique according to the present disclosure is, however, not limited to the Examples, and is applicable to other exemplary embodiments suitably made by modification, replacement, addition, or omission, for example.

### Numerical Examples

Hereinafter, numerical examples of the zoom lens system according to each of Examples 1 to 4 will be described. Each numerical example shows a table in which units of a length are all “mm”, and units of a field angle are all “^{∘}”. Each numerical example shows “r” that is a curvature radius, “d” that is a plane spacing, “nd” that is a refractive index with respect to the d line, and “vd” that is an Abbe number with respect to the d line. Each numerical example also shows a surface with a mark * that is aspherical, and an aspherical shape is defined by the expression below.

$$Z = \frac{{h}^{2} / r}{1 + \sqrt{1 - ( 1 + κ ) {( h / r )}^{2}}} + \sum {A}_{n} {h}^{n} \qquad [ Math . 1 ]$$

Z: distance from a point on the aspherical surface at a height “h” from the optical axis to a tangent plane of an aspherical vertex;
h: distance from the optical axis;
r: radius of vertex curvature;
K: conical constant; and
An: n-th aspherical coefficient.

As described above, some Examples have been described as examples of the technique disclosed in the present application. The technique according to the present disclosure is, however, not limited to the Examples, and is applicable to other exemplary embodiments suitably made by modification, replacement, addition, or omission, for example.

### First Numerical Value Example

Table 1 shows surface data, Table 2 shows various data, Table 3 shows single lens data, and Table 4 shows zoom lens group data (unit: mm) for a zoom lens system of Numerical Example 1 (corresponding to Example 1).

TABLE 1
Surface data
Surface number r d nd vd
Object surface ∞ variable
1 89.12000 4.50000 1.84666 23.8
2 54.09700 11.86000
3 89.47100 9.09000 1.84666 23.8
4 139.81000 0.20000
5 78.22400 2.50000 1.72916 54.7
6 28.59200 8.97000
7* 45.32500 4.50000 1.58480 58.7
8* 13.15600 13.48800
9 34.58400 4.99000 1.80809 22.8
10 64.01900 9.12400
11 −21.64000 1.30000 1.68430 26.8
12 −58.38200 0.20200
13 84.29700 8.16000 1.61997 63.9
14 −23.45900 0.20000
15 66.50300 10.83000 1.49700 81.6
16 −23.65000 0.30000
17 −22.79800 1.50000 1.77830 23.9
18 103.36000 1.56100
19* 101.67700 11.80000 1.80840 41.1
20* −24.02700 5.89500
21 −34.94000 2.00000 1.80610 33.3
22 276.51000 10.14100
23 −110.66000 8.52000 1.86966 20.0
24 −51.75000 0.20000
25 119.32000 12.70000 1.86966 20.0
26 −190.44000 0.20000
27 51.78100 16.26000 1.80400 46.6
28 426.70000 12.56500
29 −113.76000 2.00000 1.92286 20.9
30 113.76000 43.00000
31 −122.38000 2.00000 1.86966 20.0
32 122.38000 20.23460
33 −134.51000 13.20000 1.85883 30.0
34 −50.41000 Variable
35 96.78000 9.93000 1.80610 40.9
36 −202.08000 28.98300
37 −49.38600 2.36000 1.67270 32.2
38 37.93100 12.82700
39 87.29500 17.50000 1.43700 95.1
40 −35.39000 Variable
41 35.19000 5.74000 1.68430 26.8
42 84.90200 1.48800
43 (diaphragm) ∞ 0.20000
44 35.65200 1.50000 1.55397 71.8
45 20.43000 29.16400
46 −33.08700 1.50000 1.68893 31.2
47 406.72000 0.91200
48 106.28000 10.10000 1.43700 95.1
49 −33.02700 Variable
50 51.57500 8.93000 1.49700 81.6
51 −80.05000 0.20000
52 70.09700 1.50000 1.73800 32.3
53 27.49800 3.66100
54 33.28900 10.99000 1.43700 95.1
55 −121.01000 Variable
56 ∞ 34.60000 1.51680 64.2
57 ∞ BF
Image plane ∞
Aspherical data
Seventh surface
K = 0.00000E+00, A4 = 5.00124E−06, A6 = −2.17882E−08, A8 = 2.93752E−11
A10 = −3.25839E−14, A12 = 1.63064E−17
Eighth surface
K = −1.03566E+00, A4 = −6.86667E−06, A6 = 1.17434E−08, A8 = −3.63816E−10
A10 = 7.62346E−13, A12 = −4.48136E−16
Nineteenth surface
K = 0.00000E+00, A4 = 3.16110E−06, A6 = −1.50748E−09, A8 = 2.38550E−12
A10 = −6.32772E−16, A12 = 0.00000E+00
Twentieth surface
K = −8.57483E−01, A4 = 1.50433E−05, A6 = 4.05274E−09, A8 = 1.33101E−12
A10 = −1.10713E−14, A12 = 0.00000E+00

TABLE 2

Various data (object distance: 979.4417 mm to 1048.7004 mm)
Zoom ratio 1.06806
Wide angle Intermediate Telephoto
Focal length −5.4380 −5.6256 −5.8081
F number −2.19094 −2.19043 −2.19003
Angle of view −68.5037 −67.8035 −67.1280
Image height 14.0000 14.0000 14.0000
BF 1.71530 1.71885 1.72021
Object distance 979.4417 1014.6519 1048.7004
d34 67.7430 61.3480 55.2090
d40 3.1550 9.5500 15.6890
d49 2.6260 2.4310 2.2060
d55 16.7020 16.8970 17.1220
Various data (object distance: 640.2217 mm to 686.3889 mm)
Wide angle Intermediate Telephoto
Object distance 640.2217 662.9035 686.3889
d20 6.0962 6.0860 6.0759
d28 12.6077 12.6072 12.6066
d32 20.1918 20.1923 20.1929
Various data (object distance: 6746.9034 mm to 7209.6675 mm)
Wide angle Intermediate Telephoto
Object distance 6746.9034 6974.4484 7209.6675
d20 5.5518 5.5476 5.5433
d28 12.4613 12.4653 12.4692
d32 20.3382 20.3343 20.3303

TABLE 3

Single lens data
Lens start surface focal length
1 1 −172.7644
2 3 271.0581
3 5 −63.1428
4 7 −33.4221
5 9 86.5253
6 11 −50.9819
7 13 30.4849
8 15 36.5606
9 17 −23.8744
10 19 25.0937
11 21 −38.3719
12 23 104.7335
13 25 85.9919
14 27 71.9093
15 29 −61.3755
16 31 −70.0942
17 33 87.5309
18 35 82.4026
19 37 −31.5488
20 39 60.2360
21 41 83.8919
22 44 −89.5215
23 46 −44.3519
24 48 58.9587
25 50 64.5657
26 52 −62.2425
27 54 61.0642

TABLE 4

Zoom lens group data
Group Starting surface Focal length Lens configuration length
1 1 21.46068 253.99060
2 35 176.32808 71.60000
3 41 −1769.41731 50.60400
4 50 63.64007 25.28100

### Numerical Example 2

Table 5 shows surface data. Table 6 shows various data. Table 7 shows single lens data, and Table 8 shows zoom lens group data (unit: mm) for a zoom lens system of Numerical Example 2 (corresponding to Example 2).

TABLE 5
Surface data
Surface number r d nd vd
Object surface ∞ variable
1 89.10650 4.50000 1.84666 23.8
2 53.46000 12.38940
3 91.04270 9.00000 1.84666 23.8
4 144.93030 0.20000
5 80.75060 2.50000 1.72916 54.7
6 28.56530 8.91400
7* 44.80120 4.50000 1.58660 59.0
8* 13.21400 12.93320
9 33.96320 5.24130 1.80809 22.8
10 65.37150 9.50060
11 −22.44970 1.50000 1.68430 26.8
12 −62.39250 0.20000
13 77.15530 7.85990 1.61997 63.9
14 −24.42180 0.20000
15 69.83560 10.76020 1.49700 81.6
16 −22.46860 0.30000
17 −21.93440 2.00000 1.77830 23.9
18 106.99370 1.49370
19* 101.20910 12.26660 1.81055 41.1
20* −24.01550 5.93220
21 −34.84540 2.00000 1.80610 33.3
22 300.11150 9.90920
23 −117.47180 8.75730 1.86966 20.0
24 −52.27350 0.20000
25 126.06850 12.40700 1.86966 20.0
26 −188.79610 0.20000
27 52.10790 16.69190 1.80400 46.6
28 547.12880 12.54550
29 −112.65870 2.00000 1.92286 20.9
30 112.65870 43.00000
31 −122.06620 2.00000 1.86966 20.0
32 122.06620 20.22370
33 −136.02500 13.20000 1.85883 30.0
34 −50.59060 Variable
35 96.21800 10.12020 1.80610 40.9
36 −206.03310 29.51910
37 −49.97320 2.50000 1.67270 32.2
38 37.37400 12.86460
39 85.99340 17.50000 1.43700 95.1
40 −35.31440 Variable
41 35.12700 5.68600 1.68430 26.8
42 83.53830 1.49420
43 (diaphragm) ∞ 0.20000
44 35.52280 1.50000 1.55397 71.8
45 20.38090 29.09720
46 −32.89690 1.50000 1.68893 31.2
47 494.01420 0.89790
48 109.18020 10.14010 1.43700 95.1
49 −32.83190 Variable
50 52.10760 8.95040 1.49700 81.6
51 −79.33300 0.20000
52 69.10030 1.50000 1.73800 32.3
53 27.48080 3.65890
54 33.29190 10.95550 1.43700 95.1
55 −125.01060 Variable
56 ∞ 34.60000 1.51680 64.2
57 ∞ BF
Image plane ∞
Aspherical data
Seventh surface
K = 0.00000E+00, A4 = 5.00070E−06, A6 = −2.18582E−08, A8 = 2.90106E−11
A10 = −3.17776E−14, A12 = 1.63064E−17
Eighth surface
K = −1.03706E+00, A4 = −7.20812E−06, A6 = 1.15752E−08, A8 = −3.46449E−10
A10 = 7.37258E−13, A12 = −4.48136E−16
Nineteenth surface
K = 0.00000E+00, A4 = 3.22876E−06, A6 = −1.97386E−09, A8 = 3.42801E−12
A10 = −4.92344E−16, A12 = −2.52193E−26
Twentieth surface
K = −8.48690E−01, A4 = 1.50287E−05, A6 = 4.46498E−09, A8 = −4.28351E−13
A10 = −6.50140E−15, A12 = −3.81349E−26

TABLE 6

Various data (object distance: 982.2430 mm to 1051.6500 mm)
Zoom ratio 1.06805
Wide angle Intermediate Telephoto
Focal length −5.4381 −5.6257 −5.8081
F number −2.19128 −2.19075 −2.19034
Angle of view −68.4680 −67.7654 −67.0858
Image height 14.0000 14.0000 14.0000
BF 1.71610 1.71994 1.72037
Object distance 982.2430 1016.5500 1051.6500
d34 65.6017 59.2113 53.0740
d40 3.1631 9.5536 15.6909
d49 2.6250 2.4234 2.1903
d55 16.6978 16.8993 17.1325
Various data (object distance: 648.9340 mm to 688.3514 mm)
Wide angle Intermediate Telephoto
Object distance 648.9340 668.3514 688.3500
d20 6.1355 6.1294 6.1232
d28 12.5875 12.5894 12.5913
d32 20.1817 20.1798 20.1779
Various data (object distance: 6838.0200 mm to 7232.1900 mm)
Wide angle Intermediate Telephoto
Object distance 6838.0200 7032.3438 7232.1900
d20 5.5773 5.5754 5.5735
d28 12.4387 12.4451 12.4517
d32 20.3305 20.3240 20.3175

TABLE 7

Single lens data
Lens start surface focal length
1 1 −167.5350
2 3 268.6352
3 5 −61.8695
4 7 −33.7263
5 9 81.4055
6 11 −52.0398
7 13 30.8344
8 15 35.5811
9 17 −23.2301
10 19 25.0448
11 21 −38.6273
12 23 101.9315
13 25 88.5439
14 27 70.5725
15 29 −60.7789
16 31 −69.9138
17 33 87.5388
18 35 82.5992
19 37 −31.4243
20 39 59.9141
21 41 84.5453
22 44 −89.4706
23 46 −44.7175
24 48 59.0427
25 50 64.7444
26 52 −62.7847
27 54 61.4544

TABLE 8

Zoom lens group data
Group Starting surface Focal length Lens configuration length
1 1 21.29760 255.32570
2 35 175.42490 72.50390
3 41 −1849.94220 50.51540
4 50 63.70369 25.26480

### Numerical Example 3

Table 9 shows surface data. Table 10 shows various data. Table 11 shows single lens data, and Table 12 shows zoom lens group data (unit: mm) for a zoom lens system of Numerical Example 3 (corresponding to Example 3).

TABLE 9
Surface data
Surface number r d nd vd
Object surface ∞ variable
1 166.08750 2.00000 1.84666 23.8
2 101.70680 3.88550
3 122.84140 12.17320 1.85883 30.0
4 247.70000 0.20000
5 106.10910 2.50000 1.72916 54.7
6 31.91250 13.99050
7* 39.20630 2.16980 1.58660 59.0
8* 13.05720 15.82000
9 34.94930 6.47970 1.80809 22.8
10 54.99870 8.35990
11 −21.84760 1.50000 1.68430 26.8
12 −184.63200 0.20730
13 65.27880 7.95590 1.61997 63.9
14 −23.65520 0.20000
15 59.68740 13.56130 1.49700 81.6
16 −21.09010 0.30000
17 −20.63480 2.00000 1.77830 23.9
18 969.37530 0.36550
19* 116.59810 12.98600 1.81055 41.1
20* −30.78960 5.93090
21 −35.74080 1.50000 1.77047 29.7
22 247.17530 3.59350
23 −157.27090 7.29040 1.92286 20.9
24 −46.36680 0.20000
25 83.45150 9.80940 1.92286 20.9
26 −252.23270 7.45560
27 39.76460 20.40060 1.72825 28.3
28 73.60200 12.55570
29 −56.98570 2.00000 1.92286 20.9
30 81.91130 13.48870
31 61.75120 8.40360 1.58144 40.9
32 175.47600 8.47580
33 192.99630 2.00000 1.92286 20.9
34 72.69000 22.24340
35 −175.88420 10.88210 1.77047 29.7
36 −51.42920 Variable
37 114.65780 22.08250 1.80610 40.9
38 −139.51740 24.12560
39 −47.18050 9.54330 1.67270 32.2
40 38.64570 10.95110
41 76.82680 17.89780 1.43700 95.1
42 −35.36010 Variable
43 35.07490 5.68660 1.68430 26.8
44 83.08520 1.50190
45 (diaphragm) ∞ 0.20000
46 35.58760 1.50000 1.55397 71.8
47 20.41240 29.10160
48 −32.91170 1.50000 1.68893 31.2
49 493.84520 0.89520
50 108.91500 10.10000 1.43700 95.1
51 −32.95740 Variable
52 52.03670 8.94760 1.49700 81.6
53 −79.33330 0.20000
54 68.68840 1.50000 1.73800 32.3
55 27.46370 3.68530
56 33.34890 10.95970 1.43700 95.1
57 −124.58270 Variable
58 ∞ 34.60000 1.51680 64.2
59 ∞ BF
Image plane ∞
Aspherical data
Seventh surface
K = 0.00000E+00, A4 = 2.12289E−06, A6 = −2.34537E−08, A8 = 3.15390E−11
A10 = −3.38760E−14, A12 = 1.56466E−17
Eighth surface
K = −1.04445E+00, A4 = −7.43219E−06, A6 = 1.43578E−08, A8 = −3.44633E−10
A10 = 7.17329E−13, A12 = −4.48136E−16
Nineteenth surface
K = 0.00000E+00, A4 = 5.75047E−06, A6 = −2.13884E−09, A8 = 6.31626E−12
A10 = −1.24773E−14, A12 = −2.52293E−26
Twentieth surface
K = −9.23207E−01, A4 = 1.48328E−05, A6 = 4.87006E−09, A8 = 9.47465E−12
A10 = −2.70604E−14, A12 = −3.81015E−26

TABLE 10

Various data (object distance: 982.2430 mm to 1051.6500 mm)
Zoom ratio 1.06826
Wide angle Intermediate Telephoto
Focal length −5.4377 −5.6267 −5.8089
F number −2.19144 −2.19155 −2.19186
Angle of view −69.1157 −68.4161 −67.7464
Image height 14.0000 14.0000 14.0000
BF 1.71474 1.72277 1.72739
Object distance 982.2430 1016.5500 1051.6500
d36 63.4425 57.0203 50.9035
d42 3.1617 9.5839 15.7007
d51 2.6276 2.4212 2.1845
d57 16.6947 16.9011 17.1378
Various data (object distance: 648.9340 mm to 688.3500 mm)
Wide angle Intermediate Telephoto
Object distance 648.9340 668.3514 688.3500
d20 6.2577 6.2390 6.2203
d28 12.6313 12.6240 12.6168
d34 22.1678 22.1751 22.1823
Various data (object distance: 6838.0200 mm to 7232.1900 mm)
Wide angle Intermediate Telephoto
Object distance 6838.0200 7032.3438 7232.1900
d20 5.3971 5.3946 5.3921
d28 12.4188 12.4188 12.4189
d34 22.3803 22.3802 22.3801

TABLE 11

Single lens data
Lens start surface focal length
1 1 −314.3766
2 3 271.5237
3 5 −63.4923
4 7 −34.4301
5 9 103.6661
6 11 −36.3480
7 13 28.9996
8 15 33.2066
9 17 −25.9371
10 19 31.2848
11 21 −40.4348
12 23 69.0688
13 25 68.9133
14 27 94.7095
15 29 −36.1651
16 31 159.5370
17 33 −127.3733
18 35 90.8761
19 37 81.2242
20 39 −30.2290
21 41 58.2371
22 43 84.6307
23 46 −89.5682
24 48 −44.7354
25 50 59.1788
26 52 64.6916
27 54 −62.9783
28 56 61.4966

TABLE 12

Zoom lens group data
Group Starting surface Focal length Lens configuration length
1 1 21.11914 242.88430
2 37 174.66467 84.60030
3 43 −1724.81712 50.48530
4 52 63.53278 25.29260

### Numerical Example 4

Table 13 shows surface data. Table 14 shows various data. Table 15 shows single lens data, and Table 16 shows zoom lens group data (unit: mm) for a zoom lens system of Numerical Example 4 (corresponding to Example 4).

TABLE 13
Surface data
Surface number r d nd vd
Object surface ∞ variable
1 75.67430 8.73740 1.84666 23.8
2 127.76880 0.30000
3 51.13310 2.00000 1.92286 20.9
4 27.06770 11.81940
5* 23.88000 3.00000 1.80998 40.9
6* 12.08250 14.15220
7 203.02650 8.97130 1.72916 54.7
8 −35.73530 4.69070
9 −32.34410 8.15870 1.86966 20.0
10 84.59890 6.45000 1.72916 54.7
11 −21.35060 1.50000
12 −30.24690 1.50000 1.80809 22.8
13 1981.26140 0.50000
14* 108.76540 10.00000 1.51760 63.5
15* −27.29230 33.53530
16 −572.54580 9.57900 1.92286 20.9
17 −72.29520 0.30000
18 44.80150 7.99580 1.92286 20.9
19 63.07460 0.30000
20 38.47240 12.68490 1.84666 23.8
21 42.32880 Variable
22 −128.19470 1.50000 1.62041 60.3
23 247.63120 23.10000
24 −63.01980 1.50000 1.49700 81.6
25 37.86860 Variable
26 −164.75060 3.81050 1.86966 20.0
27 −52.74230 Variable
28 100.93070 7.33390 1.83400 37.3
29 −140.11570 5.04030
30 −65.11800 4.97780 1.76182 26.6
31 60.93720 6.03400 1.55397 71.8
32 −44.90360 Variable
33 30.63730 5.00910 1.92286 20.9
34 241.98880 1.58460
35 (diaphragm) ∞ 4.31920
36 −500.34830 1.50980 1.67270 32.2
37 18.82090 15.52050
38 −20.76490 1.50000 1.80809 22.8
39 213.45690 0.78930
40 −916.03140 4.73300 1.43700 95.1
41 −32.79810 0.52650
42 248.96220 8.90690 1.49700 81.6
43 −29.19710 0.30000
44 53.79070 1.50000 1.71736 29.5
45 35.30240 12.43000 1.49700 81.6
46 −73.82260 1.95660
47 63.53840 4.89290 1.43700 95.1
48 100.73210 Variable
49 ∞ 37.30150 1.51680 64.2
50 ∞ BF
Image plane ∞
Aspherical data
Fifth surface
K = 0.00000E+00, A4 = −1.32176E−05, A6 = −9.57761E−08, A8 = 2.33820E−10
A10 = −3.00656E−13
Sixth surface
K = −2.78586E+00, A4 = 1.36865E−04, A6 = −7.51124E−07, A8 = 2.37777E−09
A10 = −3.45691E−12
Fourteenth surface
K = 0.00000E+00, A4 = −3.29190E−06, A6 = 1.01244E−08, A8 = −4.90521E−12
A10 = 0.00000E+00
Fifteenth surface
K = 0.00000E+00, A4 = 8.77283E−06, A6 = 7.22668E−09, A8 = 2.63840E−11
A10 = 0.00000E+00

TABLE 14

Various data (object distance: 1780.3701 mm to 2204.3709 mm)
Zoom ratio 1.23376
Wide angle Intermediate Telephoto
Focal length −9.6654 −10.9829 −11.9248
F number −2.20687 −2.26743 −2.29788
Angle of view −53.9928 −50.4402 −48.1036
Image height 13.5000 13.5000 13.5000
BF 1.48384 1.48994 1.49794
Object distance 1780.3701 2027.5398 2204.3709
d21 15.4214 13.9910 12.9775
d25 19.5826 21.2529 22.4354
d27 40.8762 30.4501 23.5489
d32 0.3490 8.8606 14.3491
d48 18.6987 20.3732 21.6170
Various data (object distance: 1177.3665 mm to 1460.3135 mm)
Object distance 1177.3665 1342.3017 1460.3135
d21 15.3839 13.9549 12.9419
d25 19.6201 21.2891 22.4710
Various data (object distance: 12031.5570 mm to 14853.4950 mm)
Object distance 12031.5570 13676.7250 14853.4950
d21 15.4850 14.0523 13.0378
d25 19.5190 21.1917 22.3751

TABLE 15

Single lens data
Lens start surface focal length
1 1 203.5617
2 3 −64.9086
3 5 −34.0717
4 7 42.3447
5 9 −26.0594
6 10 23.9965
7 12 −36.8550
8 14 43.2355
9 16 88.8430
10 18 138.4874
11 20 198.8604
12 22 −135.9401
13 24 −47.3612
14 26 87.8145
15 28 71.3335
16 30 −40.6273
17 31 47.6369
18 33 37.5831
19 36 −26.9324
20 38 −23.3514
21 40 77.7131
22 42 53.1456
23 44 −148.2008
24 45 49.9410
25 47 378.6314

TABLE 16

Zoom lens group data
Group Starting surface Focal length Lens configuration length
1 1 15.70800 146.17470
2 22 −31.00798 26.10000
3 26 87.81452 3.81050
4 28 87.56895 23.38600
5 33 66.26707 65.47840

Table 17 below shows corresponding values of the conditional expressions in the respective numerical examples.

TABLE 17

| Exemplary | | | | |
|---|---|---|---|---|
| embodiments | 1 | 2 | 3 | 4 |
| (1) | 1.5 | 1.8 | 1.0 | 0.7 |
| (2) | 7.6 | 7.6 | 7.6 | 4.6 |
| (3) | 68.6 | 68.5 | 69.1 | 54.8 |
| (4) | 0.5 | 0.5 | 0.5 | 0.8 |
| (5) | 0.5 | 0.5 | 0.4 | 0.5 |

### Second Exemplary Embodiment

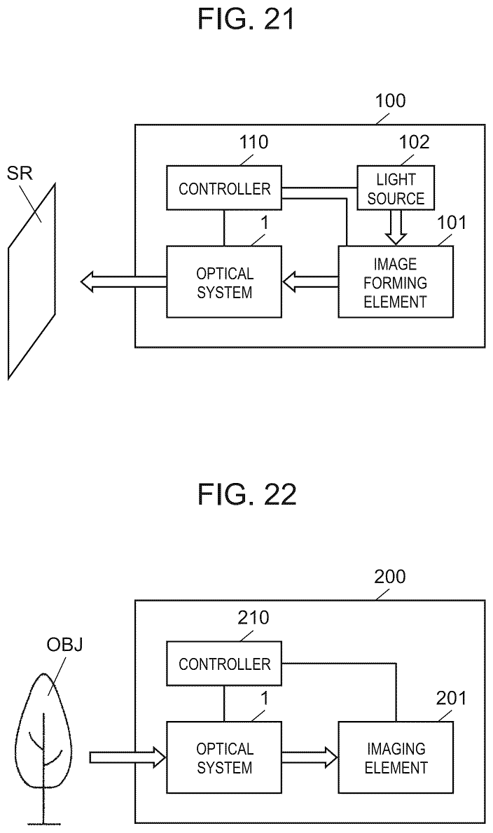

Hereinafter, a second exemplary embodiment of the present disclosure will be described with reference to FIG. 21. FIG. 21 is a block diagram illustrating an example of an image projection device according to the present disclosure. Image projection device 100 includes optical system 1 disclosed in the first exemplary embodiment, image forming element 101, light source 102, controller 110, and the like. Image forming element 101 is composed of a liquid crystal, a DMD, or the like to generate an image to be projected onto screen SR through optical system 1. Light source 102 is composed of a light emitting diode (LED), a laser, or the like to supply light to image forming element 101. Controller 110 is composed of a CPU, an MPU, or the like to control the entire device and each component. Optical system 1 may be configured as an interchangeable lens that is detachably attachable to image projection device 100. In this case, an example of a main body device is a device in which optical system 1 is removed from image projection device 100.

Image projection device 100 described above can achieve a small size, a light weight, and a wide-angle zoom function compatible with a wide projection size range by using optical system 1 according to the first exemplary embodiment.

### Third Exemplary Embodiment

Hereinafter, a third exemplary embodiment of the present disclosure will be described with reference to FIG. 22. FIG. 22 is a block diagram illustrating an example of an imaging device according to the present disclosure. Imaging device 200 includes optical system 1 disclosed in the first exemplary embodiment, imaging element 201, controller 210, and the like. Imaging element 201 is composed of a charge coupled device (CCD) image sensor, a CMOS image sensor, and the like, and receives an optical image of object OBJ formed by the optical system 1 to convert the received image into an electrical image signal. Controller 210 is composed of a CPU, an MPU, or the like to control the entire device and each component. Optical system 1 may be configured as an interchangeable lens that is detachably attachable to imaging device 200. In this case, an example of a main body device is a device in which optical system 1 is removed from imaging device 200.

Imaging device 200 described above can achieve a small size, a light weight, and a wide-angle zoom function compatible with a wide imaging distance range by using optical system 1 according to the first exemplary embodiment.

As described above, the exemplary embodiments have been described as the disclosure of the technique in the present disclosure. To this end, the accompanying drawings and detailed description have been provided.

Thus, the components described in the accompanying drawings and the detailed description include not only the components essential for solving the problem but also components that are not essential for solving the problem to exemplify the technique described above. For this reason, it should not be immediately recognized that these non-essential components are essential based on the fact that these non-essential components are described in the accompanying drawings or the detailed description.

The exemplary embodiments described above are to exemplify the technique in the present disclosure, so that various changes, substitutions, additions, omissions, and the like can be made within the scope of claims or its equivalent range.

The present disclosure is applicable to image projection devices such as projectors and head-up displays, and imaging devices such as digital still cameras, digital video cameras, monitoring cameras in monitoring systems, web cameras, and in-vehicle cameras. In particular, the present disclosure is applicable to optical systems requiring high image quality, such as a projector, a digital still camera system, and a digital video camera system.

What is claimed is:

1. An optical system including an intermediate image forming position inside the optical system, the intermediate image forming position being conjugate with each of an enlargement conjugate point on an enlargement side and a reduction conjugate point on a reduction side, the optical system comprising:
an enlargement optical system located closer to the enlargement side than the intermediate image forming position; and
a relay optical system located closer to the reduction side than the intermediate image forming position,
the relay optical system including
a positive lens element disposed on a most reduction side, and
a focusing lens group on a most enlargement side that moves in an optical axis direction during focusing,
the focusing lens group including two negative lens elements having negative power,
the optical system satisfying Expression (1) below:
$$0.65 < \vert dn / fFg 1 \vert < 2.29 \qquad Expression ( 1 )$$
where dn is a maximum value of a distance on the optical axis between the two negative lens elements, and fFg1 is a focal distance of the focusing lens group.

2. The optical system according to claim 1, further comprising ten or more lens elements including the positive lens element and the two negative lens elements.

3. The optical system according to claim 1, wherein the enlargement optical system includes a negative lens element disposed on a most enlargement side.

4. The optical system according to claim 1, wherein the focusing lens group is composed of a plurality of lens elements including a lens element disposed on the most enlargement side, the lens element including a concave surface facing the enlargement side.

5. The optical system according to claim 1, wherein the focusing lens group is composed of a plurality of lens elements including a lens element disposed on the most enlargement side, the lens element having negative power.

6. The optical system according to claim 1, wherein
Expression (2) below is satisfied,
$$1.63 < \vert BF 2 / fw \vert < 10.58 \qquad Expression ( 2 )$$
where BF2 is a minimum value of an air conversion length on a d line from the positive lens element on the most reduction side to a display element, and
fw is a focal length of an entire system at a wide angle end.

7. The optical system according to claim 1, wherein
Expression (3) below is satisfied,
$$\vert ω \vert > 30 degrees \qquad Expression ( 3 )$$
where ω is a maximum half angle of view at a wide angle end.

8. The optical system according to claim 1, wherein the optical system includes no reflecting surface having power.

9. The optical system according to claim 1, wherein the optical system includes no reflecting surface.

10. The optical system according to claim 1, wherein the focusing lens group includes three or less lens elements including the two negative lens elements.

11. The optical system according to claim 1, wherein the focusing lens group is composed of the two negative lens elements.

12. The optical system according to claim 1, wherein
Expression (4) below is satisfied,
$$0.23 < Tp / Tr < 1.11 \qquad Expression ( 4 )$$
where Tp is a distance from a surface on a most enlargement side to a surface on a most reduction side of the enlargement optical system, and
Tr is a distance from a surface on the most enlargement side of the relay optical system to a surface on a most reduction side of the relay optical system at a wide angle end.

13. The optical system according to claim 1, wherein
Expression (5) below is satisfied,
$$0.16 < fp / fr < 0.75 \qquad Expression ( 5 )$$
where fp is a focal length of the enlargement optical system at a wide angle end, and
fr is a focal length of the relay optical system at a wide angle end.

14. The optical system according to claim 1, wherein the enlargement optical system includes a lens element disposed on a most enlargement side, the lens element being fixed to the optical system during zooming.

15. An image projection device comprising:
the optical system according to claim 1; and
an image forming element that generates an image to be projected onto a screen through the optical system.

16. An imaging device comprising:
the optical system according to claim 1; and
an imaging element that receives an optical image formed by the optical system to convert the optical image into an electrical image signal.
